(19) United States
(12) Patent Application Publication
(10) Pub. No.: US 2023/0204533 A1
(43) Pub. Date: Jun. 29, 2023

(54) THERMOPLASTIC ELECTRODES FOR POTENTIOMETRIC DETECTION OF IONS

(71) Applicant: COLORADO STATE UNIVERSITY RESEARCH FOUNDATION, Fort Collins, CO (US)

(72) Inventors: Charles S. Henry, Fort Collins, CO (US); Tugba Ozer, Fort Collins, CO (US)

(73) Assignee: COLORADO STATE UNIVERSITY RESEARCH FOUNDATION, Fort Collins, CO (US)

(21) Appl. No.: 18/089,858

(22) Filed: Dec. 28, 2022

Related U.S. Application Data
(60) Provisional application No. 63/266,087, filed on Dec. 28, 2021.

(51) Int. Cl. G01N 27/333; G01N 27/416

(52) U.S. Cl. CPC G01N 27/333; G01N 27/416

(57) ABSTRACT

The present disclosure provides potentiometric ion selective electrodes, methods for preparing the potentiometric ion selective electrode, a microfluidic electrode array comprising the potentiometric ion selective electrodes, and methods of using the microfluidic electrode array to measure inorganic cations and inorganic anions in a solution.

### CROSS-REFERENCE TO RELATED APPLICATION

This application claims benefit of U.S. Provisional Patent Application No. 63/266,087, which was filed in the U.S. Patent and Trademark Office on Dec. 28, 2021, the entire contents of which are incorporated herein by reference for all purposes.

### GOVERNMENT SUPPORT CLAUSE

This invention was made with government support under 1710222 awarded by the National Science Foundation. The government has certain rights in the invention.

### FIELD OF THE DISCLOSURE

The present disclosure generally relates to potentiometric ion selective electrodes, methods for preparing the potentiometric ion selective electrode, a microfluidic electrode array comprising the potentiometric ion selective electrodes, and methods of using the microfluidic electrode array to measure inorganic cations and inorganic anions in a solution.

### BACKGROUND OF THE INVENTION

Potassium, which is vital for healthy physiology, is routinely detected in sweat [1], serum [2], urine [3], interstitial fluid [4], and brain [5] to monitor the status of individuals with cystic fibrosis [6], electrolyte imbalances [7], renal diseases, hypopotassemia, alkalosis, liver cirrhosis, and/or using diuretic drugs [8]. Conventional methods for potassium detection include flame photometry [9], ion chromatography [10], surface plasmon resonance [11], and inductively coupled plasma mass spectrometry [12]. While these methods are generally accurate and sensitive, they require expensive laboratory-based equipment. There is a growing need to measure potassium at the point-of-care (POC) due to an increasing number of patients with electrolyte imbalances resulting from consumption of high dietary potassium and/or use of certain drugs [13]. Therefore, it is important to develop miniaturized and portable sensing platforms for potassium monitoring. Besides potassium, other inorganic anions and cations are routinely monitored for various conditions such as sodium, calcium, zinc, manganese, cobalt, lithium, chloride, phosphate.

Ion-selective electrodes (ISEs) offer advantages over the aforementioned methods in that they are simple to fabricate, user-friendly, low-cost, portable and provide rapid response without the need for sample pretreatment [14].

Traditional ISEs contain an inner reference solution which limits their ability to be miniaturized for POC analysis [15]. In the last few decades, considerable progress has been made by replacing liquid contacts with solid contacts in ISEs for various applications [16, 17]. All-solid-state contact ISEs, which consist of a solid electrode substrate and ion selective membrane (ISM), can be easily miniaturized, and integrated with electronic components, allowing in-situ and continuous analyte monitoring [18]. Coated wire electrodes were introduced as solid-contact electrodes in 1970 by Cattrall and Freiser [19] but show potential instability because of the formation of a thin water layer between the metal and membrane [20]. The water layer re-equilibrates ion fluxes by acting as an electrolyte reservoir, causing mechanical failure of the ISEs [21]. Various conducting polymers including polypyrrole [22], poly(3-octylthiophene) [23], polyaniline [24], and poly(3,4-ethylenedioxythiophene) [25] have been used as effective ion-to-electron transducers. However, they cause unstable potential responses due to the formation of a water layer between the polymeric membrane and the solid contact, and interferences from light and dissolved O₂ and CO₂ [26]. In recent reports, this issue has been overcome with the use of carbon nanomaterials for solid state ISEs that give high ISE membrane/solid contact interface capacitance and increased hydrophobicity [27-29]. The water contact angle of these superhydrophobic surfaces was >150 and the sliding angle <50 [30]. Carbon black (CB) has outstanding properties such as high conductivity, good hydrophobicity, high capacitance, high surface area and has been recently demonstrated as a low-cost nanomaterial to modify glassy carbon and screen-printed electrodes, improving their electrochemical characteristics for ion detection [31]. In addition, CB has shown more stable dispersion on electrode surfaces compared to multi-walled carbon nanotubes [32] or graphene [33] without pretreatment.

Thermoplastic electrodes (TPEs) were recently introduced [34-38]. They are moldable carbon composites having excellent conductivity and electron transfer kinetics. In previous reports, TPEs were fabricated using a simple fabrication process based on a mixture of graphite or carbon black and a thermoplastic binder polymethyl methacrylate (PMMA) [34, 38, 39], polycaprolactone (PCL) [35, 38, 40], and cyclic olefin copolymer (COC) [36-38] dissolved in a volatile solvent. More recently, blends of polystyrene (PS) and PCL as a binder were investigated and found to have much lower capacitance and faster electron transfer kinetics than PCL TPEs due to their surface morphology and enhanced edge plane characteristic [41]. SEM and electrochemistry data indicate PS TPE surfaces have lower roughness and more graphitic edge-plane rich features than PCL TPEs likely owing to aromatic nature of PS which allows interactions to the graphite surfaces through π-π interactions [42]. In addition, PS-based TPEs have been demonstrated to have enhanced electron transfer kinetics compared to previously reported PS electrodes [43-46]. These electrodes would need to be suitable to distinguish between healthy and harmful potassium levels [47] in biofluids at POC.

What is needed is a potentiometric ion selective electrode which are highly sensitive, excellent stability, repeatability, and reproducibility and allows for rapid measurements.

### BRIEF DESCRIPTION OF THE FIGURES

FIG. 1 is a graphical representation of the fabrication process for the K⁺-ion selective electrode.

FIG. 2A and FIG. 2B are graphical representations of the corresponding calibration graphs obtained for potassium-selective electrodes based on MG1599 and Nano19 prepared using a two-layer design with different number of carbon black layers, by drop-casting first layers of the carbon black nanomaterial and then the membrane on the top (n=4).

FIG. 3A and FIG. 3B are graphical representations of the corresponding chronopotentiograms recorded in 0.1 M KCl solution in 10 mM HEPES at pH 7.4 using a) MG1599-b) Nano19-based K⁺-selective TPEs modified with the different number of carbon black (5 mg mL-1 in THF) layers. Current applied +1 nA for 60 s and −1 nA for 60 s. (n=3)

FIG. 4A shows the cyclic voltammetry for bare (a), CB-modified (b) and K⁺-selective Nano19-based TPE (c) in 0.1 M KCl solution, scan rate: 100 mV/s.

FIG. 4B shows the impedance spectra of the Nano19-based TPEs with (a) and without CB (b).

FIG. 4C shows the impedance spectra of the K⁺-selective Nano19-based TPE in 0.1 M KCl solution with a 0.1 Hz-100 kHz frequency range and 10 mV excitation amplitude.

FIG. 5A shows the cyclic voltammetry for bare (a), CB-modified (b) and K⁺-selective MG1599-based TPE (c) in 0.1 M KCl solution, scan rate: 100 mV/s.

FIG. 5B shows the impedance spectra of the Nano19-based TPEs with (a) and without CB (b). (C) Impedance spectra of the K⁺-selective MG1599-based TPE in 0.1 M KCl solution with a 0.1 Hz-100 kHz frequency range and 10 mV excitation amplitude.

FIG. 6A through FIG. 6F shows a series of photographs representing the SEM images of the bare Nano19-based TPE from low to high magnifications (FIG. 6A, FIG. 6B, and FIG. 6C), CB-modified Nano19-based TPE from low to high magnifications (FIG. 6D, FIG. 6E, and FIG. 6F).

FIG. 7A through FIG. 7F shows a series of photographs representing the SEM images of the bare MG1599-based TPE from low to high magnifications (FIG. 7A, FIG. 7B, and FIG. 7C), CB-modified MG1599-based TPE from low to high magnifications (FIG. 7D, FIG. 7E, and FIG. 7F).

FIG. 8A and FIG. 8B shows the calibration curve of the K⁺-selective TPEs fabricated by FIG. 8A (MG1599) and FIG. 8B (Nano19) as carbon sources for varying potassium activity in two different backgrounds including water and artificial interstitial fluid (AIF). (n=4)

FIG. 9A and FIG. 9B shows the graphical responses for the potentiometric responses (logarithmic activity vs. potential) of K⁺-selective TPEs based on FIG. 9A MG1599 and FIG. 9B Nano19 towards various interfering metabolites.

FIG. 10A and FIG. 10B shows the time dependent potentiometric responses of FIG. 10A MG1599-based and FIG. 10B Nano19-based K⁺-selective TPEs from 10-3 M to 10-2 M K⁺.

FIG. 11A and FIG. 11B show the effect of the pH on the potential response of K⁺-ISEs MG1599 (FIG. 11A) and Nano19 (FIG. 11B) in 10-2 M and 10-3 M of primary ion solutions.

FIG. 12A and FIG. 12B shows the potentiometric aqueous layer test for the K⁺-ISE prepared by MG1599 (FIG. 12A) and Nano19 (FIG. 12B) recorded in 0.1 M KCl for 1 h, 0.1 M NaCl for 2 h, and 0.1 M KCl for 1 h.

FIG. 13A shows the potentiometric responses of the reference TPEs, (a) bare, and (b-h) modified with 2-14 μL (1 layer to 7 layers) of reference membrane solution in varying concentration of Cl⁻, 10-5-1 M, in the presence of conditioning step for 16 h in 3 M KCl (n=4).

FIG. 13B shows the calibration slopes of the reference TPE against variations from 10-1 to 10-5 M KCl with a 16 h conditioning step (n=4).

FIG. 14 shows the Fabrication steps for the TPE array.

FIG. 15A and FIG. 15B shows calibration curves in artificial serum using the polymer based TPEs and the Ag/AgCl reference electrode. The calibration curves for (FIG. 15A) K⁺-selective and (FIG. 15B) Na⁺-selective TPEs obtained in artificial serum using the polymer-based reference TPE and an Ag/AgCl reference electrode. (n=4).

### SUMMARY

One aspect of the present disclosure provides a potentiometric ion selective electrode, the potentiometric ion selective electrode comprising: (a) a thermoplastic composite electrode; (b) a water impermeable layer; and (c) an ion selective membrane; wherein the water impermeable layer is layered on the surface of the thermoplastic composite electrode and wherein the ion selective membrane is layered on the surface of the water impermeable layer.

Another aspect of the present disclosure provides a method for preparing potentiometric ion selective electrodes, the methods comprising: (a) providing a thermoplastic composite electrode; (b) preparing a dispersion comprising of a water impermeable precursor; (c) applying the water impermeable layer precursor to the thermoplastic composite electrode; (d) drying the water impermeable layer precursor on the thermoplastic composite electrode forming the water impermeable layer; (e) preparing a dispersion of an ion selective membrane precursor; (f) applying the ion selective membrane precursor on the water impermeable layer; (g) drying the ion selective membrane precursor forming the ion selective membrane electrode; and (h) conditioning the ion selective membrane electrode; wherein the thermoplastic composite is in contact with an electrical conductor.

In still another aspect, the present disclosure provides a microfluidic electrode array, the microfluidic electrode array comprising one or more potentiometric ion selective electrodes described below and a reference electrode; wherein the microfluidic electrode array is affixed to a hydrophilic base substrate.

Other features and iterations of the invention are described in more detail below.

### DETAILED DESCRIPTION

Described herein are potentiometric ion selective electrodes, a method for preparing potentiometric ion selective electrode, and a microfluidic array comprising the ion selective electrode and a reference electrode. The potentiometric ion selective electrodes are highly sensitive, excellent stability, repeatability, and reproducibility and allows for rapid measurements. The microfluidic array measures activities of inorganic anions and inorganic cations in solutions.

### I. Potentiometric Ion Selective Electrode

In one aspect, disclosed herein, are potentiometric ion selective electrodes. The potentiometric ion selective electrodes include: (a) a thermoplastic composite electrode; (b) a water impermeable layer; and (c) an ion selective layer; wherein the water impermeable layer is layered on the surface of the thermoplastic composite electrode and wherein the ion selective membrane is layered on the surface of the water impermeable layer. With the inclusion of the water impermeable layer, the potentiometric ion electrode is highly sensitive, highly stable, highly repeatable, highly reproducible, allows for rapid measurements in a sample, and has a duration of operability up to 6 months.

### (a) a Thermoplastic Composite Electrode

The potentiometric ion selective electrode includes a thermoplastic composite electrode. In one embodiment, the thermoplastic composite electrode is a thermoplastic carbon composite electrode. The thermoplastic carbon composite electrode includes a uniform dispersion of a plastic binder and a carbon allotrope. Methods of preparing a thermoplastic carbon composite electrode are disclosed in U.S. Pat. No. 10,679,765 which is incorporated by reference.

Generally, the plastic binder(s) is dissolved in a solvent forming a plastic binder mixture; the carbon allotrope is contacted with the plastic binder mixture forming a carbon allotrope plastic binder mixture; mixing the carbon allotrope plastic binder mixture until a uniform carbon allotrope plastic binder mixture is obtained; partially drying the carbon allotrope plastic binder mixture to prepare a thermoplastic composite; shaping the a thermoplastic carbon composite electrode; and etching the plastic binder at the surface of the a thermoplastic carbon composite, thereby at least partially exposing the carbon allotrope. The thermoplastic carbon composite is in electrical contact with an electrical conductor to form the thermoplastic composite electrode.

One or more plastic binders may be used in the thermoplastic composite. Suitable, non-limiting examples of binder(s) include polystyrene, polycaprolactone, polypropylene, polyethylene, polyaniline, polyurethane, polyacrylate, or combinations thereof. In certain embodiments, the binder(s) includes polystyrene and polycaprolactone.

Generally, the amount of the one or more blinders in the thermoplastic composite may range from about 1.0 wt. % to about 99.0 wt. % based on the total weight of the thermoplastic carbon composite. In various embodiments, the amount of the one or more blinders in the thermoplastic composite may range from about 1.0 wt. % to about 99.0 wt. %, from about 20.0 wt. % to about 80.0 wt. %, or from about 30.0 wt. % to about 70 wt. %.

A carbon allotrope may be used in the thermoplastic composite. Suitable, non-limiting examples of carbon allotropes include graphite, expanded graphite, graphite oxide, graphene, boron doped diamond, graphene oxide, graphene, glassy carbon, vitreous carbon, carbon nanotubes, carbon nanoplatelets, carbon black, fullerenes, or a combination thereof. In other embodiments, the carbon allotropes are functionalized. Suitable, non-limiting functionalized carbon allotropes include amino, hydroxy, oxo, alkoxy, or halide functionalized allotropes.

In other embodiments, the carbon allotropes include doped carbon materials. The doped carbon materials include sulfur, nitrogen, other elements, or diatomic molecules.

In one embodiment, the carbon allotrope may be carbon black (CB).

In general, the amount of the carbon allotrope in the thermoplastic composite may range from about 1.0 wt. % to about 99.0 wt. % based on the total weight of the thermoplastic composite. In various embodiments, the amount of the carbon allotrope in the thermoplastic carbon composite may range from about 1.0 wt. % to about 99.0 wt. %, from about 20.0 wt. % to about 80.0 wt. %, or from about 30.0 wt. % to about 70 wt. %.

The thermoplastic composite is in electrical contact with an electrical conductor to form the thermoplastic composite electrode. The electrode conductor is any material which efficiently conducts an electrical signal. Suitable, non-limiting examples of these materials may be a copper wire.

### (b) a Water Impermeable Layer

The potentiometric ion selective electrode includes a water impermeable layer. The water impermeable layer is layered on the surface of the thermoplastic composite electrode. The water impermeable layer provides exclusion of water to the thermoplastic composite electrode and increases the sensitivity of the data obtained.

A variety of water impermeable layers may be used in the potentiometric ion selective electrode. Suitable, non-limiting examples of the water impermeable layer may be a carbon nanomaterial, metal nanoparticles, magnetic nanoparticles, a conductive polymer, or combinations thereof.

In various embodiments, the water impermeable layer includes a carbon nanomaterial. Suitable, non-limiting examples of carbon nanomaterials may be graphite, expanded graphite, graphite oxide, graphene, boron doped diamond, graphene oxide, graphene, glassy carbon, vitreous carbon, carbon nanotubes, carbon nanoplatelets, carbon black, fullerenes, or a combination thereof.

In other embodiments, the water impermeable layer includes a metal nanoparticle. Suitable, non-limiting examples of metal nanoparticles may be transition metal nanoparticles, transition metal nanorods, transition metal nanoflowers, transition metal microspheres, transition metal oxide nanoparticles, transition metal oxide nanorods, transition metal oxide nanoflowers, transition metal oxide nanospheres, or a combination thereof. In certain embodiments, the water impermeable layer may be gold nanoparticles, gold nanorods, gold nanoflowers, platinum nanoparticles, zinc oxide nanorods, cupric oxide nanoflowers, molybdenum dioxide microsphere, and ruthenium dioxide nanoparticles.

In yet another, the water impermeable layer includes a polymer-based nanomaterial. Suitable, non-limiting examples of polymer-based nanomaterials may be natural, synthetic, or semisynthetic polymers in the nanoscale range. Suitable, non-limiting examples of these polymer-based nanomaterials may be polyaniline nanoparticles, polymer doped-nanoparticles such as Fe3O4-chitosan, zinc oxide nanoparticles intercalated into polypyrrole, polyaniline-gold nanoparticles, Au/PANI core-shell nanocomposite, polypyrrole nanoparticles, and polyvinyl(alcohol) coated polypyrrole. The polymers may be a natural polymer. Suitable non-limiting examples of these natural polymers may be cellulose, hemicellulose, glucomannan, agar, starch, pectin, inulin, rosin, acacia gum which have plant origin, chitin, chitosan, and alginate which have animal origin and biopolymers (exopolysaccharides) such as levan, alternan which have microorganism origin. These polymers may be also synthetic polymer such as polyacetylene (PA), polyaniline (PANI), polypyrrole (PPy), polythiophene (PTH), poly(para-phenylene) (PPP), poly(phenylenevinylene) (PPV), and polyfuran (PF).

In still another embodiment, the water impermeable layer includes a conductive polymer. Suitable, non-limiting examples of these conductive polymers may include polyphenylenes, polypyrenes, polyazulenes, polynaphthalenes, polypyrroles, polycarbazoles, polyindoles, polyazepines, polyanilines, polythiophenes, poly(p-phenylene sulfide), polyacetylenes, poly(p-phenylene)vinylidenes, or a combination thereof. Specific examples of these conductive polymers may be polytrioctylthiophene (POT), polyethylenedioxythiophene (PEDOT), polyaniline (PANI), or polypyrrole (PPy).

In yet another embodiment, the water impermeable layer may be magnetic nanoparticles. Suitable, non-limiting examples of the magnetic nanoparticles may be ferrites, ferrites with a shell, metallic nanoparticles with a shell, or a combination thereof. The shell of the ferrites or metallic nanoparticles may include silica, transition metal oxides, surfactants, polymers, graphene, and precious metals.

In one embodiment, the water impermeable layer includes graphite.

Generally, the thickness of these membranes may range from about 1.0 nm to about 10,000 nm. In various embodiments, the thickness of these membranes may range from about 1.0 nm to 10,000 nm, from about 10 nm to about 1,000 nm, or from about 100 nm to about 500 nm.

### (c) Ion Selective Membrane

The potentiometric ion selective membrane includes an ion selective membrane. The ion selective membrane is layered on the surface of the water impermeable membrane. This ion selective membrane specifically binds inorganic anions or inorganic cations which allows for an accurate measurement of activity of the inorganic anions or inorganic cations in the solution. Suitable, non-limiting examples of ion selective membrane include an ionic liquid, a lipophilic additive, an ionophore, polymer, a plasticizer, or a combination thereof.

In one embodiment, the ion selective membrane includes an ionic liquid. In some aspects, the ionic liquid is used as an ionophore to detect anions. In other aspects, the ionic liquid is used as an anion excluder for measuring the activity of cations. The ionic liquids useful in the ion selective membrane include an ammonium salt, an imidazolium salt, a morpholinium salt, a phosphonium salt, a piperidinium salt, a pyridinium salt, a pyrrolidinium salt, or a sulfonium salt. Suitable, non-limiting examples of these ionic liquids, include but not limited 1-methyl-3-n-octylimidazolium bis(trifluoromethyl-sulfonyl) imide, tetramethylammonium chloride, methyltridodecylammonium tetrakis(pentafluorophenyl)borate, tetrabutylammonium tetrabutylborate, methyltridodecylammonium tetrakis(4-chlorophenyl) borate, 1-methyl-3-octylimidazoliumbis (trifluoromethylsulfonyl)imide, 1-methyl-3-octylimidazoliumbis(trifluoromethylsulfonyl)imide, 1-butyl-3-methylimidazoliumtris(pentafluoroethyl)trifluorophosphate (or 1-hexyl-3-methylimidazolium), 1-methyl-3-octylimidazolium bis(trifluoromethylsulfonyl)imide, 1-methyl-3-octylimidazolium bis(trifluoromethylsulfonyl)imide, octyl-3-methylimidazoliumbis(trifluoromethylsulfonyl)imide, or 1-dodecyl-3-methylimidazoliumbis(trifluoromethylsulfonyl)imide.

In another embodiment, the ion selective membrane includes an ionophore. In one embodiment, the ionophore may be a neutral molecule which binds an inorganic cation or an inorganic anion. Ionophores may be a metal-ion complex, isoalloxazine derivatives, a crown ether, a phthalocyanine, porphyrins, or metalloporphyrins. Suitable, non-limiting examples of these ionophores may be a lipophilic fluoro ketones such as trifluoroacetyl-p-heptylbenzene; salofenes, thiourea derivatives, bis(thiourea)derivative, silver thiourea derivatives, p-hexyltrifluoroacetylbenzoate, or organomercury compounds; valinomycin, tetranactin, ETH 1001, ETH 231, tris(2-octyl-oxyethyl) amine, or tertbutylcalixarene; or charged ionophores such as potassium ionophore I, calcium ionophore II, sodium ionophores X, calcium didecylphosphate, bis[4-(1,1,3,3-tetramethylbutyl)phenyl]phosphate, guanidinium bases and derivatives of guanidinium bases, potassium tetrakis(4-chlorophenyl)borate, sodium tetrakis[3,5-bis(trifluoromethyl)phenyl] borate, potassium tetrakis[3,5-bis-(trifluoromethyl)phenyl]borate, tridodecylmethylammonium chloride, potassium tetraphenylboroic acid, derivatives of the tetraphenylboronic acid; crown ethers such as benzo-15-crown 5; phthalocyanines such as nickel phthalocyanines, iron phthalocyanines, Co(III) phthalocyanines, derivatives of phthalocyanines, porphyrins such as 5,10,15,20-tetra(4-pyridyl)-21H, 23H-porphine, 3,7,12,17-tetramethyl-8,13-divinyl 2,18-porphine dipropionic acid, 4,4′,4″,4′″-21H, 23H-porphine-5,10,15,20-tetrayl) tetrakis (benzoic acid), 2,3,7,8,12,13,17,18-octamethyl-21H, 23H-porphine, or carbamates such as cyanomethyl N-methyl-N-phenyl dithiocarbamate.

In yet another embodiment, the ion selective membrane include a polymer. Suitable, non-limiting examples of the polymers may be high molecular weight poly(vinyl chloride) (PVC), carboxylated PVC, poly(vinyl acetate), poly(vinylbutyral), fluorosilicone, silicon rubbers, acrylic polymers, acrylsiloxanes, urethanes, acrylicsiloxane polymers, methacryl-acryl copolymer, polyurethane and urethane-acrylic copolymer, poly (3,4 ethylenedioxythiophene), poly (styrenesulfonate), fluorous polymers, acrylic acid/acrylonitrile, poly(butyl acrylate), poly(methyl methacrylate), and poly(methyl methacrylate)polystyrene copolymer.

In still another embodiment, the ion selective membrane includes a plasticizer. Suitable, non-limiting examples of these plasticizers may be 2-nitrophenyl octyl ether, bis(butylpentyl)adipate, bis(2-ethylhexyl)sebacate, dioctylphthalate, or tri(2-ethylhexyl) phosphate.

In one embodiment, the ion selective membrane may be an ionophore.

In general, the thickness of these membranes may range from about 1.0 nm to about 10,000 nm. In various embodiments, the thickness of these membranes may range from about 1.0 nm to 10,000 nm, from about 10 nm to about 1,000 nm, or from about 100 nm to about 500 nm.

### (d) Properties of the Potentiometric Ion Selective Electrode.

The potentiometric ion selective electrode can detect various inorganic cations and inorganic anions. The ability to detect various inorganic cations and inorganic anions depends on the ion selective membrane used to prepare the potentiometric ion selective electrode. Suitable, non-limiting examples of these inorganic cation and inorganic anions may be K⁺, Na⁺, Ca²⁺, Mg²⁺, H⁺, Li⁺, Rb⁺, NH4⁺, Be²⁺, Sr²⁺, Ba²⁺, Cu²⁺, Ag⁺, Zn²⁺, Cd²⁺, Hg²⁺, Fe³⁺, Fe²⁺, Pb+², Ni²⁺, Pb⁴⁺, CO₃²⁻, HCO₃—, SCN⁻, NO₃⁻, NO₂⁻, Cl⁻, SO₄²⁻ HPO₄²⁻, PO₄³⁻, H₂PO₄⁻, or ClO₄⁻.

The potentiometric ion selective electrode has a size ranging from about 10 μm to about 1000 mm. In various embodiments, the size of the potentiometric ion selective electrode ranges from about 10 μm to about 1000 mm, from about 100 μm to about 500 mm, or about 200 μm to about 100 mm.

Generally, the potentiometric ion selective electrodes can detect an inorganic anion and inorganic cation at a concentration ranging from about 1.0×10⁻⁵ M (moles per liter) to about 1.0 M. In various embodiments, the potentiometric ion selective electrode can detect an inorganic anion and inorganic cation at a concentration ranging from about 1.0×10⁻⁵ M to about 1.0 M, from about 1.0×10⁻⁴ M to about 0.1 M, or from about 1.0×10⁻³ to about 1.0×10⁻².

The potentiometric ion selective electrode exhibits a Nernstian response to K⁺ with sensitivity of 59.3±1.01 mV decade⁻¹ and near-Nernstian response with sensitivity of 56.8±1.7 mV decade⁻¹ within a linear range of 0.0001 M to 0.1 M with a limit of detection of 0.0001 M.

The potentiometric ion selective electrode demonstrates a rapid response (statistically significant), excellent stability, repeatability, and reproducibility.

In general, the potentiometric ion selective electrode has a duration ranging from 1 to 6 months before the potentiometric ion electrode needs to be re-calibrated, certified, or replaced.

### II. Methods of Preparing Potentiometric Ion Selective Electrodes

In another aspect, disclosed herein, are methods of preparing potentiometric ion selective electrodes. The method comprising: (a) providing a thermoplastic composite electrode; (b) preparing a dispersion comprising of a water impermeable precursor; (c) applying the water impermeable precursor to the thermoplastic composite electrode; (d) drying the water impermeable precursor on the thermoplastic composite electrode forming the water impermeable layer; (e) preparing a dispersion of an ion selective membrane precursor; (f) applying the ion selective membrane precursor on the water impermeable layer; and (g) drying the ion selective membrane precursor forming the ion selective membrane electrode.

### (a) Providing a Thermoplastic Composite Electrode

The thermoplastic composite electrode is described in more detail above.

### (b) Preparing a Dispersion Comprising of a Water Impermeable Precursor

The next step in preparing the thermoplastic composite electrode is preparing the dispersion of the water impermeable precursor. Once the precursor is applied and dried, the water impermeable layer is formed.

A variety of water impermeable precursors may be used in the potentiometric ion selective electrode. Suitable, non-limiting examples of the water impermeable layer precursors may be a carbon nanomaterial, metal nanoparticles, magnetic nanoparticles, a conductive polymer, or combinations thereof.

In various embodiments, the water impermeable layer precursor includes a carbon nanomaterial. Suitable, non-limiting examples of carbon nanomaterials may be graphite, expanded graphite, graphite oxide, graphene, boron doped diamond, graphene oxide, graphene, glassy carbon, vitreous carbon, carbon nanotubes, carbon nanoplatelets, carbon black, fullerenes, or a combination thereof.

In other embodiments, the water impermeable layer precursor includes a metal nanoparticle. Suitable, non-limiting examples of metal nanoparticles may be transition metal nanoparticles, transition metal nanorods, transition metal nanoflowers, transition metal microspheres, transition metal oxide nanoparticles, transition metal oxide nanorods, transition metal oxide nanoflowers, transition metal oxide nanospheres, or a combination thereof. In certain embodiments, the water impermeable layer may be gold nanoparticles, gold nanorods, gold nanoflowers, platinum nanoparticles, zinc oxide nanorods, cupric oxide nanoflowers, molybdenum dioxide microsphere, and ruthenium dioxide nanoparticles.

In still another embodiment, the water impermeable layer precursor includes a polymer-based nanomaterial precursor. Suitable, non-limiting examples of polymer-based nanomaterial precursors may be natural, synthetic, or semisynthetic polymers in the nanoscale range. Suitable, non-limiting examples of these polymers may be natural polymers such as cellulose, hemicellulose, glucomannan, agar, starch, pectin, inulin, rosin, acacia gum which have plant origin, and chitin, chitosan, and alginate which have animal origin, and biopolymers (exopolysaccharides) such as levan, alternan which have microorganism origin. These polymers can be also synthetic such as polyacetylene (PA), polyaniline (PANI), polypyrrole (PPy), polythiophene (PTH), poly(para-phenylene) (PPP), poly(phenylenevinylene) (PPV), and polyfuran (PF).

Suitable, non-limiting examples of these polymer-based nanomaterial precursors may be polyaniline nanoparticles, polymer doped-nanoparticles such as Fe3O4-chitosan, zinc oxide nanoparticles intercalated into polypyrrole, polyaniline-gold nanoparticles, Au/PANI core-shell nanocomposite, polypyrrole nanoparticles, polyvinyl(alcohol) coated polypyrrole etc.

In still another embodiment, the water impermeable layer precursor includes a conductive polymer. Suitable, non-limiting examples of these conductive polymers may include polyphenylenes, polypyrenes, polyazulenes, polynaphthalenes, polypyrroles, polycarbazoles, polyindoles, polyazepines, polyanilines, polythiophenes, poly(p-phenylene sulfide), polyacetylenes, poly(p-phenylene)vinylidenes, or a combination thereof. Specific examples of these conductive polymers may be polytrioctylthiophene (POT), polyethylenedioxythiophene (PEDOT), polyaniline (PANI), or polypyrrole (PPy).

In yet another embodiment, the water impermeable layer precursor may be magnetic nanoparticles. Suitable, non-limiting examples of the magnetic nanoparticles may be ferrites, ferrites with a shell, metallic nanoparticles with a shell, or a combination thereof. The shell of the ferrites or metallic nanoparticles may include silica, transition metal oxides, surfactants, polymers, graphene, and precious metals.

In one embodiment, the water impermeable layer includes graphite.

The concentration of the water impermeable layer precursor in a solvent forming a dispersion can and will vary depending on the specific water impermeable layer precursor used, the solvent utilized, and the number of applications applied to the thermoplastic carbon composite electrode. Generally, the concentration of the water impermeable layer precursor in a solvent forming a dispersion may range from about 0.1 mg/mL to about 10 mg/mL. In various embodiments, the concentration of the water impermeable layer precursor in a solvent forming a dispersion may range from about 0.1 mg/mL to about 10 mg/mL, from about 1.0 mg/mL to about 90 mg/mL, or from about 2.5 mg/mL to about 7.5 mg/mL. In one embodiment, the concentration of the water impermeable layer precursor in a solvent forming a dispersion may be about 5.0 mg/mL.

Step (b), as detailed herein, may include a solvent. As recognized by those of skill in the art, the solvent can and will vary depending on the water impermeable precursor used in the method. The solvent may be a polar protic solvent, a polar aprotic solvent, a non-polar solvent, or combinations thereof. Suitable examples of polar protic solvents include, but are not limited to, water; alcohols such as methanol, ethanol, isopropanol, n-propanol, iso-butanol, n-butanol, s-butanol, t-butanol, and the like; diols such as propylene glycol; organic acids such as formic acid, acetic acid, and so forth; amines such as trimethylamine, or triethylamine, and the like; amides such as formamide, acetamide, and so forth; and combinations of any of the above. Non-limiting examples of suitable polar aprotic solvents include acetonitrile, dichloromethane (DCM), diethoxymethane, N,N-dimethylacetamide (DMAC), N,N-dimethylformamide (DMF), dimethyl sulfoxide (DMSO), N,N-dimethylpropionamide, 1,3-dimethyl-3,4,5,6-tetrahydro-2(1H)-pyrimidinone (DMPU), 1,3-dimethyl-2-imidazolidinone (DMI), 1,2-dimethoxyethane (DME), dimethoxymethane, bis(2-methoxyethyl)ether, 1,4-dioxane, N-methyl-2-pyrrolidinone (NMP), ethyl formate, formamide, hexamethylphosphoramide, N-methylacetamide, N-methylformamide, methylene chloride, nitrobenzene, nitromethane, propionitrile, sulfolane, tetramethylurea, tetrahydrofuran (THF), 2-methyltetrahydrofuran, trichloromethane, and combinations thereof. Suitable examples of non-polar solvents include, but are not limited to, alkane and substituted alkane solvents (including cycloalkanes), aromatic hydrocarbons, esters, ethers, combinations thereof, and the like. Specific non-polar solvents that may be employed include, for example, benzene, butyl acetate, t-butyl methylether, chlorobenzene, chloroform, chloromethane, cyclohexane, dichloromethane, dichloroethane, diethyl ether, ethyl acetate, diethylene glycol, fluorobenzene, heptane, hexane, isopropyl acetate, methyltetrahydrofuran, pentyl acetate, n-propyl acetate, tetrahydrofuran, toluene, and combinations thereof. In one embodiment, the solvent may be THF.

In general, the reaction of Step (b) will be conducted at a temperature that ranges from about 0° C. to about 40° C. depending on the solvent utilized. In various embodiments, the temperature of the reaction may range from about 0° C. to about 40° C., from about 10° C. to about 30° C., or from about 20° C. to about 25° C. In one embodiment, the reaction may be conducted at temperature about 23° C. The formation of the dispersion preparation typically is performed under ambient pressure. The dispersion preparation may also be conducted under an inert atmosphere, for example under nitrogen, argon, or helium.

A variety of methods are known to prepare the dispersion. Suitable, non-limiting examples of preparing the dispersion may be mixing (e.g., magnetic or mechanical), sonication, or shaking. In one embodiment, the method of preparing the dispersion is using sonication.

Generally, the preparation of the dispersion is allowed to proceed for a sufficient period of time until the dispersion is visually complete. The duration of the dispersion preparation may range from about 5 minutes to about 2 hours. In some embodiments, the duration of the dispersion preparation may range from about 5 minutes to about 30 minutes, from about 30 minutes to about 1 hours, or from about 1 hour to about 2 hours. In an embodiment, the dispersion preparation may be allowed to proceed for about 1 hour.

### (c) Applying the Water Impermeable Layer Precursor to the Thermoplastic Composite Electrode

The next step in the method encompasses applying the water impermeable layer precursor to the thermoplastic composite electrode.

Various methods are known to apply the water impermeable layer precursor to the to the thermoplastic composite electrode. Suitable, non-limiting examples of applying the water impermeable layer precursor to the thermoplastic composite electrode may be painting, spraying, or drop casting. In one embodiment, the water impermeable layer precursor is applied to the to the thermoplastic composite electrode by drop casting.

In general, the application will be conducted at a temperature that ranges from about 0° C. to about 40° C. depending on the solvent utilized. In various embodiments, the application may range from about 0° C. to about 40° C., from about 10° C. to about 30° C., or from about 20° C. to about 25° C. In one embodiment, the reaction may be conducted at temperature about 23° C. The application typically is performed under ambient pressure. The application may also be conducted under an inert atmosphere, for example under nitrogen, argon, or helium.

### (d) Drying the Water Impermeable Layer Precursor on the Thermoplastic Composite Electrode Forming the Water Impermeable Layer

The next step in the method includes drying the water impermeable layer precursor on the thermoplastic carbon composite electrode forming the water impermeable layer. The drying is normally conducted in an atmosphere with low amounts of moisture in the atmosphere present such as a desiccator.

Generally, the drying of the water impermeable layer will be conducted at a temperature that ranges from about 0° C. to about 40° C. In various embodiments, the drying may range from about 0° C. to about 40° C., from about 10° C. to about 30° C., or from about 20° C. to about 25° C. In one embodiment, the drying may be conducted at temperature about 23° C. The drying is typically performed under ambient pressure. The drying may also be conducted under an inert atmosphere, for example under nitrogen, argon, or helium.

Generally, the drying is allowed to proceed until the layer visually appears to be dry. The duration of the drying may range from about 1 second to about 24 hours. In some embodiments, the duration of the dispersion preparation may range from about 1 second to about 24 hours, from about 1 minute to about 12 hours, or from about 10 minutes to about 1 hour. In an embodiment, the drying may be allowed to proceed for about 5 seconds.

After the drying of the initial water impermeable layer precursor, one or more layers of the water impermeable layer may be applied.

### (e) Preparing a Dispersion of an Ion Selective Membrane Precursor

The next step in the method is to prepare the dispersion of the ion selective membrane precursor. The dispersion of the ion selective membrane precursor may further include a plasticizer which aids in binding the ion selective membrane precursor to the water impermeable layer.

A variety of ion selective membrane precursors can be used. Suitable, non-limiting examples of ion selective membrane precursors includes an ionic liquid or a lipophilic additive, an ionophore, a polymer, or a plasticizer. These materials are disclosed in more detail above.

In general, the preparation of the dispersion in Step (e) will be conducted at a temperature that ranges from about 0° C. to about 40° C. depending on the solvent utilized. In various embodiments, the temperature of the reaction may range from about 0° C. to about 40° C., from about 10° C. to about 30° C., or from about 20° C. to about 25° C. In one embodiment, the reaction may be conducted at temperature about 23° C. The formation of the dispersion preparation typically is performed under ambient pressure. The dispersion preparation may also be conducted under an inert atmosphere, for example under nitrogen, argon, or helium.

A variety of methods are known to prepare the dispersion. Suitable, non-limiting examples of preparing the dispersion may be mixing (e.g., magnetic or mechanical), sonication, or shaking. In one embodiment, the method of preparing the dispersion is using sonication.

Generally, the preparation of the dispersion is allowed to proceed for a sufficient period of time until the dispersion is visually complete. The duration of the dispersion preparation may range from about 1 minutes to about 2 hours. In some embodiments, the duration of the dispersion preparation may range from about 1 minutes to about 30 minutes, from about 30 minutes to about 1 hours, or from about 1 hour to about 2 hours. In an embodiment, the dispersion preparation may be allowed to proceed for about 1 hour.

### (f) Applying the Ion Selective Membrane Precursor on the Water Impermeable Layer

The next step in the method is to apply the ion selective membrane precursor.

Various methods are known to apply the ion selective membrane precursor to the to the water impermeable layer. Suitable, non-limiting examples of applying the ion selective membrane precursor on the water impermeable layer may be painting, spraying, or drop casting. In one embodiment, the ion selective membrane precursor is applied on the water impermeable layer by drop casting.

In general, the application will be conducted at a temperature that ranges from about 0° C. to about 40° C. depending on the solvent utilized. In various embodiments, the application may range from about 0° C. to about 40° C., from about 10° C. to about 30° C., or from about 20° C. to about 25° C. In one embodiment, the reaction may be conducted at temperature about 23° C. The application typically is performed under ambient pressure.

The application may also be conducted under an inert atmosphere, for example under nitrogen, argon, or helium.

### (g) Drying the Ion Selective Membrane Precursor Forming the Ion Selective Membrane Electrode

The next step in the method is drying the ion selective membrane precursor forming the ion selective membrane electrode. The drying is normally conducted in an atmosphere with low amounts of moisture in the atmosphere present such as a desiccator and in a dark environment.

Generally, the drying of the ion selective membrane precursor will be conducted at a temperature that ranges from about 0° C. to about 40° C. In various embodiments, the drying may range from about 0° C. to about 40° C., from about 10° C. to about 30° C., or from about 20° C. to about 25° C. In one embodiment, the drying may be conducted at temperature about 23° C. The drying is typically performed under ambient pressure. The drying may also be conducted under an inert atmosphere, for example under nitrogen, argon, or helium.

Generally, the drying is allowed to proceed until the layer visually appears to be dry. The duration of the drying may range from about 5 minutes to about 48 hours.

In some embodiments, the duration of the dispersion preparation may range from about 5 minutes to about 48 hours, from about 6 hours to about 36 hours, or from about 12 hours to about 24 hours. In an embodiment, the drying may be allowed to proceed for about 18 hours (overnight).

### (h) Conditioning the Ion Selective Membrane Electrode

The last step in the method is to condition the ion selective membrane electrode. Conditioning is a procedure that is done to re-sensitize the electrodes to the analyte (the ion being measured) after storage before calibration/measurement. For each potentiometric ion selective electrode, the electrode is conditioned in an aqueous solution of the primary ion which the ion-selective electrode is selective to. Therefore, for a K⁺ potentiometric ion selective electrode, the electrode is conditioned using a K⁺ ionic solution (e.g., KCl, KNO3).

The concentration of the ionic solution ranges from about 0.01 M to about 1.0 M. In various embodiments, the concentration of the ionic solution ranges from about 0.01 M to about 1.0 M, from about 0.05 M to about 0.5 M, or from about 0.08 to about 0.12 M. In one embodiment, the concentration of the ionic solution is about 0.1 M.

### III. A Reference Electrode

In an additional aspect, as disclosed herein, are reference electrodes. The reference electrode includes: (a) a thermoplastic composite electrode; (b) a nanomaterial or conductive polymer; (c) a silver/silver chloride ink; and (d) a reference membrane; wherein the nanomaterial or conductive polymer is layered on the surface of the thermoplastic composite electrode; wherein the silver/silver chloride ink is layered on the nanomaterial or conductive polymer, and wherein the reference membrane is layered on the surface of the silver/silver chloride ink.

A reference electrode is an electrode which has a stable and well-known electrode potential. The reference electrode is used in the microfluidic array which allows for the potential of the potentiometric ion selective electrode to be easily and accurately measured. The reference electrode is of any size but normally, the reference is generally a similar size as the potentiometric ion selective electrode which ranges from 10 μm to about 10 mm. In one embodiment, the reference electrode may be solid-state electrode.

The reference electrode is in electrical contact with an electrical conductor. The electrode conductor is any material which efficiently conducts an electrical signal. Suitable, non-limiting examples of these materials may be a copper wire.

A wide variety of reference electrodes may be used in the microfluidic electrode array. Suitable, non-limiting examples of the reference electrodes may be a standard hydrogen electrode, a normal hydrogen electrode, a reversible hydrogen electrode, a saturate calomel electrode, a silver/silver chloride electrode, a copper-copper(II) sulfate electrode, or a solid-state electrode. In one embodiment, the reference electrode may be solid-state electrode modified with silver/silver chloride ink and poly(butyl methacrylate-co-methyl methacrylate) membrane prepared by drop-casting.

### IV. Microfluidic Electrode Arrays

In another aspect, as disclosed herein, are microfluidic arrays. The microfluidic electrode array includes one or more potentiometric ion selective electrodes as disclosed above and a reference electrode wherein the electrodes are affixed to a base substrate where the one or more potentiometric ion selective electrodes and the reference electrodes are separately connected to an electrical conductor. The array can measure one or more inorganic anions and inorganic cations rapidly.

### (a) One or More Potentiometric Ion Selective Electrodes

The potentiometric ion selective electrodes are described in more detail above.

### (b) Reference Electrode

The reference electrode is described in more detail above.

### (c) Base Substrate

The microfluidic array is affixed to a hydrophilic base substrate. The hydrophilic base substrate may be of various sizes and dimensions suitable enough to affix the potentiometric ion selective electrode and the reference electrode. Suitable, non-limiting examples of suitable base substrates may be paper, plastic, Teflon, glass, silk, or a cloth impregnated with a water repelling material. These substrates may be in various sizes and forms. Suitable, non-limiting examples of these forms may be a sheet, a series of overlapping sheets, a wool (e.g., glass wool), or a mesh. In one embodiment, the base substrate may be paper. Utilization of paper as a base substrate allows the preparation of a fast-flow microfluidic paper-based analytical device called a mPAD which comprises one or more potentiometric ion selective electrodes and a reference electrode on a paper base substrate.

(d) connection

With the one or more potentiometric ion selective electrode(s) and the reference electrode each in separate a connection through separate electrical contact with an electrical conductor, the microfluidic array provides rapid and sensitive readings of the inorganic anion and inorganic anion in a solution.

The microfluidic array through this electrical conductor is connected through a microprocessor through this connection. This connection may be a wired connection or a wireless connection. Suitable, non-limiting examples of these microprocessors may be a pH meter, a potentiostat, a hand-held computing device (e.g. a smart phone), or a computer. In another embodiment, the signals derived from the potentiometric ion selective electrode may be multiplexed. This indicates that multiple input signals may be combined over one shared medium then separated in the output. By multiplexing, various concentrations of different ions can be determined.

The microfluidic array may be part of an electrode cartridge. This electrode cartridge may be a part of a hand-held mobile electrode cartridge device, a remote electrode cartridge device, or a fixed electrode cartridge device connected to a fixed item.

In an embodiment, the electrode cartridge may be part of a hand-held mobile electrode cartridge device. In this hand-held mobile electrode cartridge device, the electrode cartridge may be used to measures a sample of blood serum or urine from a sample provided from a patient.

In another embodiment, the electrode cartridge may be part of a remote electrode cartridge device. In the remote electrode cartridge device, the device may be connected to a mammal or human being through a connection with the skin or to the blood system which measures the concentration of inorganic anions and inorganic cation in the perspiration, the skin, or the blood stream. The remote electrode cartridge may also be connected to a fixed item where the concentration of the inorganic anions and inorganic cations may be measured periodically.

In yet another embodiment, the electrode cartridge may be part of a fixed monitoring system. This fixed monitoring system would provide monitoring of inorganic cations and inorganic anions over a period of time. Fixed items include but not limited to a pipe, a reactor, a faucet, a drainage system, a water well, an oil prospecting well, or an oil production well.

### V. Methods of Using the Microfluidic Array

In yet another aspect, disclosed herein, are methods of using the microfluidic array. The methods include measuring the inorganic anions or inorganic cations concentration in tap water, rain water, blood serum, urine, perspiration, ocular fluids, oil field liquids, gas exploration fields, fracking liquids, sea water, drainage water from agriculture field, industrial water waste, mine drainage water, water from municipal water treatment, river water, lake water, creek water, well water, or aquifer water. The methods use a hand-held mobile electrode cartridge device, a remote electrode cartridge device, or a fixed monitoring system.

### Definitions

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of +5%, 10%, 20%, or +25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%. For example, repeat unit A is substantially soluble (e.g., greater than about 95% or greater than about 99%) in a polar organic solvent and is substantially insoluble (e.g., less than about 5% or less than about 1%) in a fluorocarbon solvent. In another example, repeat unit B is substantially soluble (e.g., greater than about 95% or greater than about 99%) in a fluorocarbon solvent and is substantially insoluble (e.g., less than about 5% or less than about 1%) in a polar organic solvent.

A “solvent” as described herein can include water or an organic solvent.

Examples of organic solvents include, but are not limited to, hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

Further examples of useful organic solvents include any organic solvent in which the starting materials and reagents are sufficiently soluble to provide reaction products. Examples of such organic solvents may include ketones such as cyclohexanone and methyl amyl ketone; alcohols such as 3-methoxybutanol, 3-methyl-3-methoxybutanol, 1-methoxy-2-propanol, and 1-ethoxy-2-propanol; ethers such as propylenegylcol monomethyl ether, ethylenegylcol monomethyl ether, propylenegylcol monoethyl ether, ethylenegylcol monoethyl ether, propylenegylcol dimethyl ether, and diethyleneglycol dimethyl ether; esters such as propylenegylcol monomethyl ether acetate, propylenegylcol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylenegylcol mono-tert-butyl ether acetate, and lactones such as γ-butyrolactone. These organic solvents may be used alone or in a mixture of two or more kinds thereof but are not limited thereto.

The term “functional group” refers to specific groups (moieties) of atoms or bonds within molecules (for example, organic chemical compounds and polymers) that are responsible, for example, for the characteristic chemical reactions of those molecules (or interactions with other molecules or ions). The same functional group can undergo the same or similar chemical reaction(s) regardless of the size of the molecule it is a part of.

However, its relative reactivity can be modified by other functional groups nearby. The atoms of functional groups are linked to each other and to the rest of the molecule by covalent bonds. Functional groups can also be charged, e.g. in carboxylate salts (—COO—), or ammonium salts which turns the molecule into a polyatomic ion or a complex ion. Functional groups binding to a central atom in a coordination complex are called ligands, but they can also interact with ions to form chemical gradients. The functional group can be tethered to a polymer, such as a group of atoms comprising, for example, carbon, nitrogen, oxygen that are covalently bonded together. The group of atoms may have additional substituents that also include, for example, carbon, nitrogen, oxygen, but can also include other atoms that are known in the field of organic chemistry, organometallic chemistry, polymer chemistry, analytical chemistry, and electrochemistry.

The term “lower alkyl” refers to a branched or unbranched hydrocarbon having, for example, from 1-20 carbon atoms, and often 1-12, 1-10, 1-8, 1-6, or preferably 1-4 carbon atoms. As used herein, the term “alkyl” also encompasses a “cycloalkyl”, defined below. Examples include, but are not limited to, methyl, ethyl, propyl, butyl, pentyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like.

The term “surface roughness” refers to a component of surface texture. It is quantified by the deviations in the direction of the normal vector of a real surface from its ideal form. If these deviations are large, the surface is rough; if they are small, the surface is smooth. In surface metrology, roughness is typically considered to be the high-frequency, short-wavelength component of a measured surface. The amplitude and frequency can be determined to ensure that a surface is fit for a purpose.

The term “gasket” as disclosed herein refers to a mechanical seal which fills the space between two or more mating surfaces, generally to smooth-out irregularities from the joined objects while under compression. Gaskets allow for “less-than-perfect” mating surfaces on machine parts where they can fill irregularities and reduce the number of open pores. For example, a gasket having a flat, smooth surface that is in contact with the surface of a polymer gel, when under pressure during molding, will create a smoother surface on the surface of the polymer gel than the surface formed on the polymer gel that is molded without a gasket. The gasket also provides an evenly applied pressure that can be sustained and prolonged at the surface of the thermoplastic composite, as the soft, gum-like electrode material is hardening via heating or solvent evaporation.

This disclosure provides ranges, limits, and deviations to variables such as volume, mass, percentages, ratios, etc. It is understood by an ordinary person skilled in the art that a range, such as “number 1” to “number 2”, implies a continuous range of numbers that includes the whole numbers and fractional numbers. For example, 1 to 10 means 1, 2, 3, 4, 5, . . . , 9, 10. It also means 1.0, 1.1, 1.2, 1.3, . . . , 9.8, 9.9, 10.0, and also means 1.01, 1.02, 1.03, and so on. If the variable disclosed is a number less than “number 10”, it implies a continuous range that includes whole numbers and fractional numbers less than number 10, as discussed above. Similarly, if the variable disclosed is a number greater than “number 10”, it implies a continuous range that includes whole numbers and fractional numbers greater than number 10. These ranges can be modified by the term “about”, whose meaning has been described elsewhere in this disclosure.

As various changes could be made in the above-described electrodes, arrays, and methods without departing from the scope of the invention, it is intended that all matter contained in the above description and in the examples given below, shall be interpreted as illustrative and not in a limiting sense.

### Materials

Methylene chloride was sourced from Thermo Fisher Scientific. Polystyrene (molecular weight 45,000) was sourced from Sigma-Aldrich. Nano19 carbon nanoplatelets and MG1599 were purchased from Asbury Carbons and Great Lakes Graphite, respectively. Vulcan XCMAX22 Carbon Black was obtained from Cabot Corporation (Boston, USA). The material properties of the conductive carbons are listed in Table 1 shown below:

TABLE 1
Type, size, and purity of conductive carbons utilized

| Carbon | Type | Particle diameter | Purity (%) |
|---|---|---|---|
| Nano19 | Carbon nanoplatelets | ~5.48 μm | 99.85 |
| MG1599 | Natural flake graphite | ~15 μm | 99.5-99.99 |

Potassium ionophore (valinomycin), potassium tetrakis(4-chlorophenyl)borate (KTChPB), 2-nitrophenyl octyl ether (o-NPOE), bis(2-ethylhexyl) sebacate (DOS), sodium tetrakis-[3,5-bis(trifluoromethyl)phenyl]borate (NaTFPB), and high molecular weight polyvinyl chloride (PVC) were the selectophore reagents obtained from Sigma-Aldrich. Tetrahydrofuran (THF), also from Sigma-Aldrich, was freshly distilled before use. Sodium hydroxide (NaOH, 1 N) was obtained from J. T. Baker. HEPES, free acid, and HCl were purchased from Sigma-Aldrich. The pH of the solutions was adjusted by additions of NaOH or HCl. CaCl2, MgCl2, NaCl, Na2CO3, Na2HPO4, glucose, sucrose was analytical grade and purchased from Sigma-Aldrich. AIF was prepared by mixing Na2HPO4 (1.5 mM), NaCl (10 mM), MgCl2 (0.7 mM), CaCl2 (2.5 mM), sucrose (7.4 mM), and glucose (5.5 mM) in 10 mM HEPES at pH 7.4 in varying concentration of KCl immediately prior to use according to the procedure described in the literature [47, 48]. Normal urine from pooled human donors was purchased from Lee BioSolutions Inc and used for urine sample analysis. All aqueous solutions were prepared with Milli-Q water (18.2 MΩ·cm) and electrolyte solutions were prepared by sequential dilution of 10-1 M stock KCl.

### EXAMPLES

### Example 1: Electrode Fabrication

1 g of thermoplastic (1:1 ratio of PS:PCL) was dissolved in 15 mL of methylene chloride and mixed with carbon source: plastic at a 2:1 ratio as a TPE material. Electrode templates with a 3.175 mm thickness were made from Optix poly(methyl methacrylate) (PMMA) sheets obtained from Plaskolite. After electrode templates were designed with the graphic design program CoreIDRAW, they were cut with an Epilog CO₂ laser cutter to have 2.5 mm inner diameter. Electrodes were heat pressed at pressures of 300-500 psi and 190° C. with a manually operated hydraulic heated press. After that, excess electrode material was removed from the TPE surface using 150 grit sandpaper. A Fluke 187 multimeter (0.01Ω accuracy) was used to test conductivity. Finally, electrical connections were made with conductive silver paint, copper wires, and epoxy. TPEs were polished for 2 min with wet 150 grit sandpaper followed by 1 min 600 grit sandpaper before use.

### Example 2: Preparation of Ion-Selective Membrane

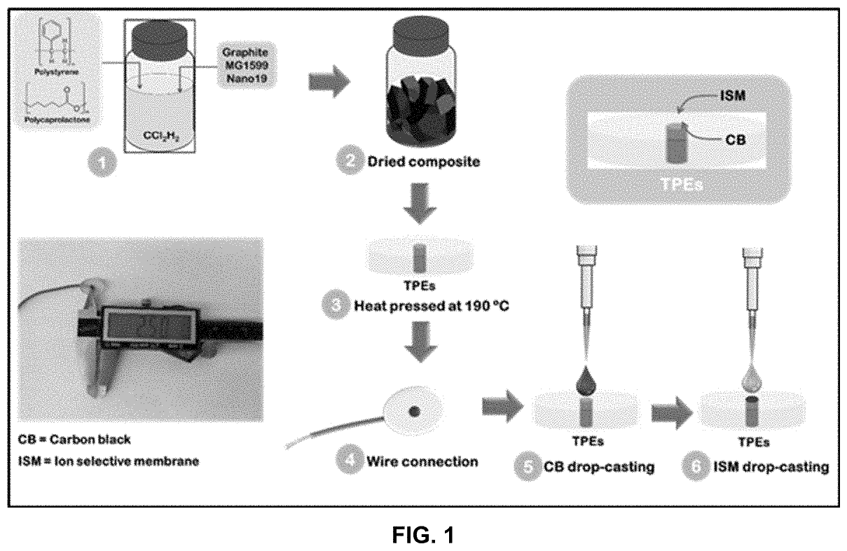

The ISM cocktail was prepared by dissolving 0.20 g of the membrane components in 1.5 mL of THF. The compositions of K⁺-ISM were as follows: 2% (w/w) valinomycin, 0.5% KTChPB (w/w), 65% (w/w) DOS, and 32.5% (w/w) high molecular weight PVC. Other membranes containing different ratios were additionally tested for membrane optimization and presented in Table 2 which is shown below. The membrane cocktails were sonicated for 30 min. 5 mg mL-1 CB dispersion was prepared in THF and sonicated for 30 min. After the electrodes were modified with CB in two aliquots (1.5 μL×2), the membrane solution was drop-casted on TPE surface in three aliquots (2 μL×3) and let THF evaporate in a desiccator for overnight in ambient conditions to form ion-selective membrane. The fabrication steps of ISEs are presented in FIG. 1. For comparison study, some electrodes were left unmodified with carbon black nanomaterial. Finally, K⁺-selective TPEs were conditioned in 0.1 M potassium chloride solution for overnight and the conditioning step was performed prior to potentiometric measurements. Whereas all electrodes were conditioned and stored separately, four identical electrodes for each type were prepared and investigated. Calibration curves were obtained for all electrodes in the concentration range of 10-1-10-6 M.

TABLE 2
Compositions of potassium-selective membranes
(plasticizer:PVC, w/w 2:1)

| | Plasticizer | Additive | Additive | Ionophore |
|---|---|---|---|---|
| Membrane | type | type | (wt. %) | (wt. %) |
| M1 | DOS | KTChPB | 0.3 | 2 |
| M2 | DOS | KTChPB | 0.5 | 2 |
| M3 | NPOE | KTChPB | 0.3 | 2 |
| M4 | NPOE | KTChPB | 0.5 | 2 |
| M5 | DOS | NaTFPB | 0.5 | 2 |
| M6 | DOS | NaTFPB | 0.8 | 2 |
| M7 | NPOE | NaTFPB | 0.5 | 2 |
| M8 | NPOE | NaTFPB | 0.8 | 2 |
| M9 | DOS | KTChPB | 0.6 | 2 |
| M10 | DOS | KTChPB | 0.8 | 2 |
| M11 | DOS | NaTFPB | 0.9 | 2 |

### Example 3: Electrochemical Measurements

Potentiometric measurements were conducted using a portable computer-controlled electrochemical analyzer (PalmSens4, The Netherlands) with a two-electrode system. A home-made reference silver chloride electrode Ag/AgCl/3M KCl was used during electrochemical measurements. The electromotive force (EMF) measurements were performed with the following cell assembly: Ag/AgCl (reference electrode) I sample solution I TPE (indicator electrode). Activity coefficients were calculated to convert concentrations to activities using the extended Debye-Hückel equation [49]. Each logarithmic activity was then plotted against the corresponding steady-state potential. The selectivity of electrodes were evaluated using the separate solution method according to Bakker et al. [50]. Individual calibration graphs were obtained for the primary (K⁺) and the interfering metabolites including Na⁺, Mg2⁺, Ca2⁺, sucrose, glucose, HPO4-, NO3-, CO32-. The chronopotentiometric measurements were conducted with the use of a CHI 660b Electrochemical System (Austin, Tex.) in the presence of a three-electrode cell. While a TPE was connected as a working electrode, a Ag/AgCl/3M KCl electrode and a Pt wire were used the reference and counter electrode, respectively. Sartorius model PR50 pH meter (USA) was used for pH measurements.

### Example 4: Optimization of Membrane Composition and Potentiometric Responses of TPEs

EMF (electromotive force) of the potentiometric cell was evaluated between 10-6-10-1 M KCl in HEPES at pH 7.4 by successively increasing and then decreasing the potassium concentration. The slope obtained for the linear portion of the calibration curves and detection limits calculated as the intersection of the two slope lines are presented in Table 3. The plasticizers and lipophilic additives used as membrane components significantly affect the polymeric membrane characteristics of the ISEs. While plasticizer decreases the electrical membrane resistance, it increases ionophore mobility [51]. It has been reported that addition of 0.5 mass units of a plasticizer to 1 mass unit of PVC is sufficient for suitable elasticity [52]. According to Tables 3 and 4, the PVC membranes plasticized with DOS with a dielectric constant of ε=4.8 showed a higher potential response slope (56.8±1.7 mV decade-1 for MG1599-based TPE and 59.3±1.01 mV decade-1 for Nano19-based TPE) and improved detection limit (1.0×10-4 M) to K⁺ compared to the PVC/o-NPOE (E=24) membrane. While DOS is often used for ISEs selective for monovalent ions, o-NPOE as plasticizer is more suitable for preparation of polymeric membranes to detect divalent ions [53].

Tables 3 and 4 also show the slope values measured using the potentiometric response versus the logarithm of potassium activity for TPEs modified with CB. The slopes of electrode responses with M2-ISM were closer to the theoretical Nernstian slope when compared to those calculated for the corresponding electrodes without CB. Also, the K⁺-selective TPEs prepared with M2-ISM displayed a broad dynamic range response over the concentration range of 0.1 mM to 100 mM with a slope of 56.8±1.7 mV/log[aK⁺] and 59.3±1.01 mV/log[aK⁺] for MG1599 and Nano19, respectively. The limit of detection (LOD) was calculated to be 100 μM according to the IUPAC definition for both MG1599 and Nano19 TPEs modified with CB [54].

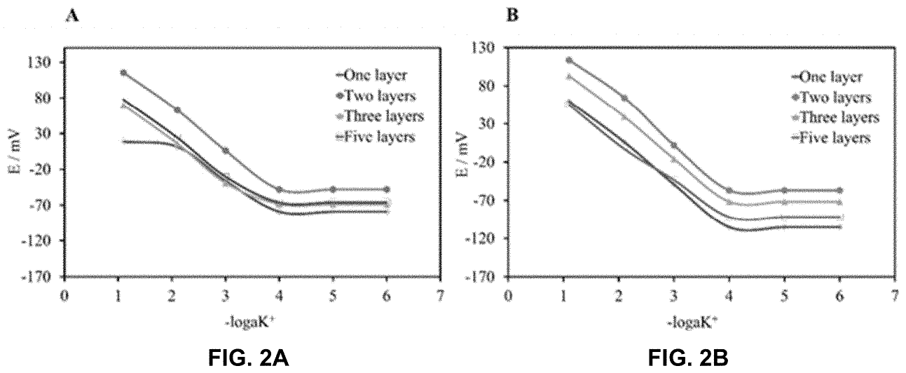

For optimizing CB modification, various numbers of layer thicknesses from one to five were evaluated by drop-casting 1.5 μL (5 mg mL-1) CB in THF on TPE surfaces. After drying, ISM cocktail (2 μL×3) was coated on modified TPEs, allowing each layer to dry for 10 min. The TPEs were tested in varying activity of K⁺ ions and obtained calibration curves were presented in FIG. 2A and FIG. 2B. The analytical performance for potassium in terms of the linear response range (from 10-4 to 10-1.1 activity) improved from one to two layers and then plateaued at three and five layers of added carbon black for TPEs fabricated using MG1599. On the other hand, thickness of the carbon black layers had no effect on the linear response range for K⁺-selective TPEs fabricated using Nano19. The slopes of linear portion for electrodes prepared with MG1599 were 45.25±2.1, 56.8±1.7, 45.32±0.99 and 48.6±3.3 mV/log [aK⁺] for one, two, three and five layers of carbon black, respectively, whereas they were 55.02±1.24, 59.3±1.01, 54.95±0.99 and 48.15±0.5 mV/log [aK⁺] for the TPEs prepared with Nano19 as a carbon source. The potassium-selective TPEs coated with two layer-CB/ISM had slopes closer to the Nernstian response relative to other tested TPEs. We hypothesize that the increased nanomaterial layer thickness prevents the formation of an aqueous layer between the membrane and the substrate, thus improving sensitivity [47]. Therefore, two-layer CB modification was selected for further experiments.

TABLE 3
Analytical parameters from CB-modified potassium-selective
TPE prepared with K⁺-ISM containing different ratios.

| | | Slope | LOD | Linear range |
|---|---|---|---|---|
| Carbon type | Membrane | (mV) | (activity) | (activity) |
| MG1599 | M1 | 32.2 ± 1.3 | 10⁻⁴ | 10⁻⁴-10^{-2.1} |
| MG1599 | M2 | 56.8 ± 1.7 | 10⁻⁴ | 10⁻⁴-10^{-1.1} |
| MG1599 | M3 | 51.9 ± 0.20 | 10⁻⁴ | 10⁻⁴-10^{-1.1} |
| MG1599 | M4 | 38.0 ± 2.1 | 10⁻⁴ | 10⁻⁴-10^{-2.1} |
| MG1599 | M5 | 54.9 ± 0.8 | 10⁻⁴ | 10⁻⁴-10^{-1.1} |
| MG1599 | M6 | 53.8 ± 0.8 | 10⁻⁴ | 10⁻⁴-10^{-1.1} |
| MG1599 | M7 | 52.6 ± 0.29 | 10⁻⁴ | 10⁻⁴-10^{-1.1} |
| MG1599 | M8 | 53.3 ± 0.69 | 10⁻⁴ | 10⁻⁴-10^{-1.1} |
| MG1599 | M9 | 51.2 ± 0.2 | 10⁻⁴ | 10⁻⁴-10^{-1.1} |
| MG1599 | M10 | 53.8 ± 0.91 | 10⁻⁴ | 10⁻⁴-10^{-1.1} |
| MG1599 | M11 | 51.36 ± 1.3 | 10⁻⁴ | 10⁻⁴-10^{-1.1} |

### Example 5: Chronopotentiometry

TABLE 4
Analytical parameters from CB-modified potassium-selective
TPE prepared with K⁺-ISM containing different ratios.

| Carbon | | Slope | LOD | Linear range |
|---|---|---|---|---|
| type | Membrane | (mV) | (activity) | (activity) |
| Nano19 | M1 | 57.67 ± 1.45 | 10⁻⁴ | 10⁻⁴-10^{-1.1} |
| Nano19 | M2 | 59.3 ± 1.01 | 10⁻⁴ | 10⁻⁴-10^{-1.1} |
| Nano19 | M3 | 55.2 ± 0.5 | 10⁻³ | 10⁻³-10^{-1.1} |
| Nano19 | M4 | 48.04 ± 1.5 | 10⁻³ | 10⁻³-10^{-1.1} |
| Nano19 | M5 | 55.6 ± 1.3 | 10⁻⁴ | 10⁻⁴-10^{-1.1} |
| Nano19 | M6 | 53.5 ± 0.5 | 10⁻⁴ | 10⁻⁴-10^{-1.1} |
| Nano19 | M7 | 53.1 ± 2.4 | 10⁻⁴ | 10⁻⁴-10^{-1.1} |
| Nano19 | M8 | 53.45 ± 0.21 | 10⁻⁴ | 10⁻⁴-10^{-1.1} |
| Nano19 | M9 | 51.8 ± 0.28 | 10⁻⁴ | 10⁻⁴-10^{-1.1} |
| Nano19 | M10 | 52.1 ± 0.15 | 10⁻⁴ | 10⁻⁴-10^{-1.1} |
| Nano19 | M11 | 53.5 ± 0.87 | 10⁻⁴ | 10⁻⁴-10^{-1.1} |

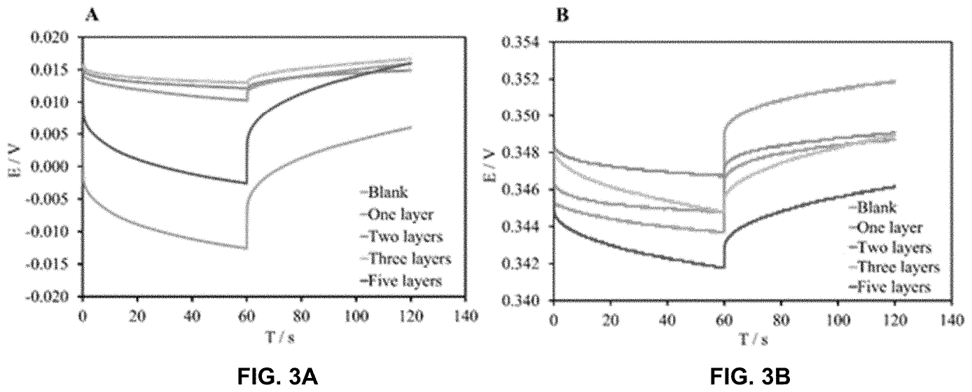

To calculate electrode capacitance and potential drift, unmodified electrodes and electrodes modified with different numbers of CB nanomaterial layers were tested using chronopotentiometry in the three-electrode cell together. After +1 nA current was applied for 0-60 s, −1 nA current was applied for 60-120 s in 10-1 M KCl. The recorded chronopotentiograms are presented in the FIG. 3A and FIG. 3B. The ΔEdc/Δt=I/C equation presented Bobacka et al. [55] was used to determine electrical capacitance (C) values based on the obtained potential difference (ΔEdc) and the applied current (I) (1 nA) at the time (t) of 60 s. The electrical capacitance of the solid-contact layer without CB was easily polarized once a constant current of ±1 nA was applied, resulting in a dramatic potential change of 24.5±6.2 mV and 7.2±1.1 mV at 60 s for MG1599 and Nano19-based TPEs, respectively. According to Table 5, the addition of one layer of CB to the TPE surface significantly increased capacitance (13.6±4.5 μF and 16.5±4.9 pF) and reduced potential drift (4.7±1.6 mV and 3.8±1.1 mV) compared to the unmodified K⁺-selective TPEs (2.5±0.6 μF and 8.5±1.3 μF), indicating the improved stability of the CB-modified K⁺-selective TPEs based on MG1599 and Nano19, respectively. As can be seen in Table 5, two and three layers of CB modified K⁺-selective TPEs showed higher capacitance and lower potential drifts compared to unmodified TPEs. On the other hand, five layers of CB nanomaterial modification did not give stable chronopotentiograms and had a similar capacitance value (2.5±0.10 μF) to unmodified electrodes (2.5±0.6 μF) for MG1599-based TPE since the layer was too thick. Due to the higher electrical capacitance values for both types of TPEs, the two-layer CB coating was selected for further experiments. For TPEs made of Nano19 as a carbon source, the electrical capacitance of the solid-contact layer created with two layers of CB was slightly higher than two layer CB modified TPEs made of MG1599 as a carbon source, which is expected due to the smaller particle size of Nano19 (˜5.48 μm) graphite compared to MG1599 (˜15 μm) graphite. In Table 6, the K⁺-ISEs were compared in terms of potential drifts, demonstrating that CB modified TPEs are promising for developing ion-selective electrodes owing to their small potential drift and high electrical capacitance.

TABLE 5
Capacitance and EMF drift of the K⁺-ISEs measured by
chronopotentiometry at ±1 nA. (n = 3)

| Number of | | | | | | |
|---|---|---|---|---|---|---|
| carbon black | MG1599 | | | Nano19 | | |
| layers | ΔE (mV) | ΔE/Δt (μV/s) | C (μF) | ΔE (mV) | ΔE/Δt (μV/s) | C (μF) |
| blank | 24.5 ± 6.2 | 407.5 ± 102.5 | 2.5 ± 0.6 | 7.2 ± 1.1 | 119.9 ± 18.7 | 8.5 ± 1.3 |
| 1 | 4.7 ± 1.6 | 78.3 ± 25.9 | 13.6 ± 4.5 | 3.8 ± 1.1 | 63.35 ± 18.88 | 16.5 ± 4.9 |
| 2 | 3.2 ± 0.2 | 52.5 ± 3.5 | 19.04 ± 0.8 | 1.5 ± 1.0 | 45.85 ± 5.87 | 22.0 ± 2.8 |
| 3 | 3.2 ± 0.4 | 52.45 ± 5.87 | 19.2 ± 2.1 | 5 ± 0.7 | 58.35 ± 11.81 | 17.5 ± 3.5 |
| 5 | 24.5 ± 6.6 | 407.5 ± 102.9 | 2.5 ± 0.10 | 8.5 ± 2 | 57.5 ± 24.7 | 19.2 ± 8.3 |

TABLE 6
Comparison of potentiometric parameters of solid-contact K⁺-ISM
electrodes in the literature

| | Potential | |
|---|---|---|
| Electrode | Drift (μV/s) | Reference |
| GCD/RuO₂•xH₂O/K⁺-ISM | 81 | [60] |
| GCD/RuO₂ + POT/K⁺-ISM | 86 | [61] |
| GCD/POT/K⁺-ISM | 798 | [61] |
| CB/TPE (MG1599 and Nano19)/K⁺-ISM | 52.5, 45.8 | This disclosure |

### Example 6: Characterizations of the K⁺-Selective TPEs

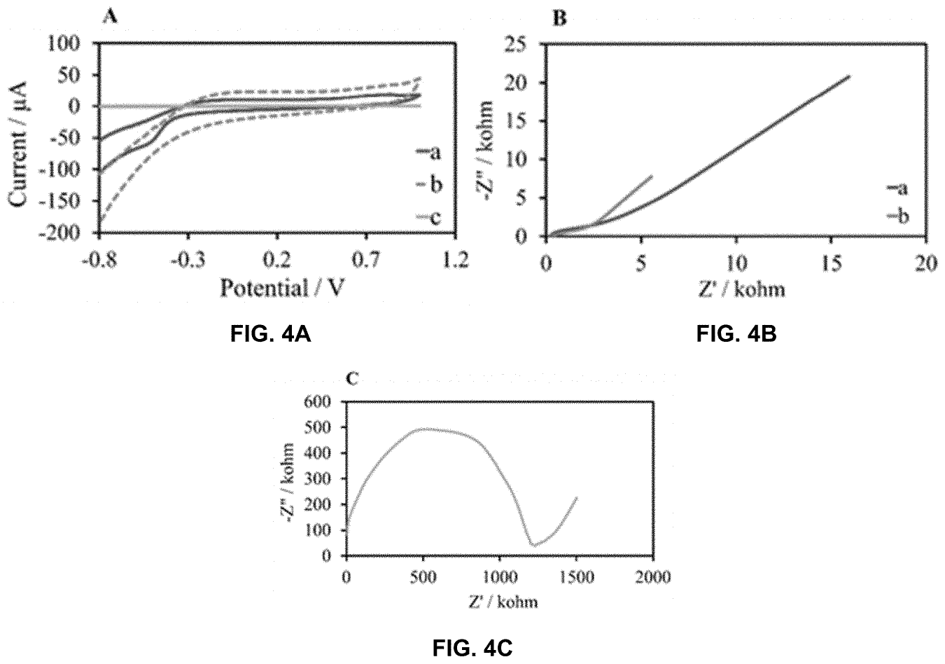

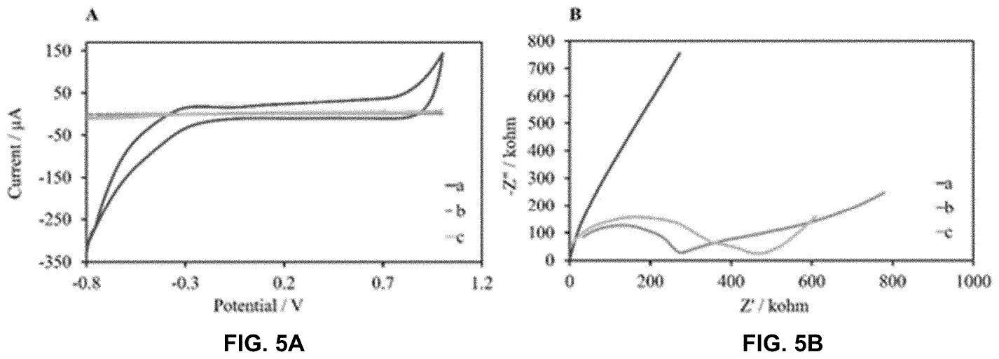

Bare, CB (carbon black)-modified and CB-ISM-modified TPEs were investigated using cyclic voltammetry in the potential range between −0.8 V and 1 V in 0.1 M KCl solution at pH 7.4. As can be seen in FIG. 4A (b line), capacitive current obtained for CB-modified TPE was higher than the bare TPE (a line). In previous reports, multi-walled carbon nanotubes, single-walled carbon nanotubes, and thermally reduced graphene oxide modified electrodes exhibited higher background current compared to CB-modified electrodes [56], which is in agreement with our study. In addition, the impedance spectra for the bare TPEs and K⁺-selective TPEs with and without CB layer were measured by the electrochemical impedance spectroscopy (EIS) in 0.1 M KCl with a 0.1 Hz-100 kHz frequency range and 0.2 V excitation amplitude and, presented in FIG. 4B and FIG. 4C and FIG. 5B. According to the Nyquist plots in FIG. 4B and FIG. 4C, CB-modified TPE based on Nano19 had a smaller Rct (1917Ω) compared to bare TPEs (2858Ω), indicating faster charge-transport. Based on these results, it was concluded that CB-modified Nano19-based TPE is more suitable for fabricating ISE compared to MG1599-based TPE since CB-modified TPE based on Nano19 showed a smaller Rct than CB-modified TPE based on MG1599 (258 kΩ) (FIG. 5B). The impedances of polymeric membrane ISEs were 1.28 MΩ and 0.38 MΩ for Nano- and MG1599-based TPEs, respectively, which are high and in agreement with previously reported studies [57].

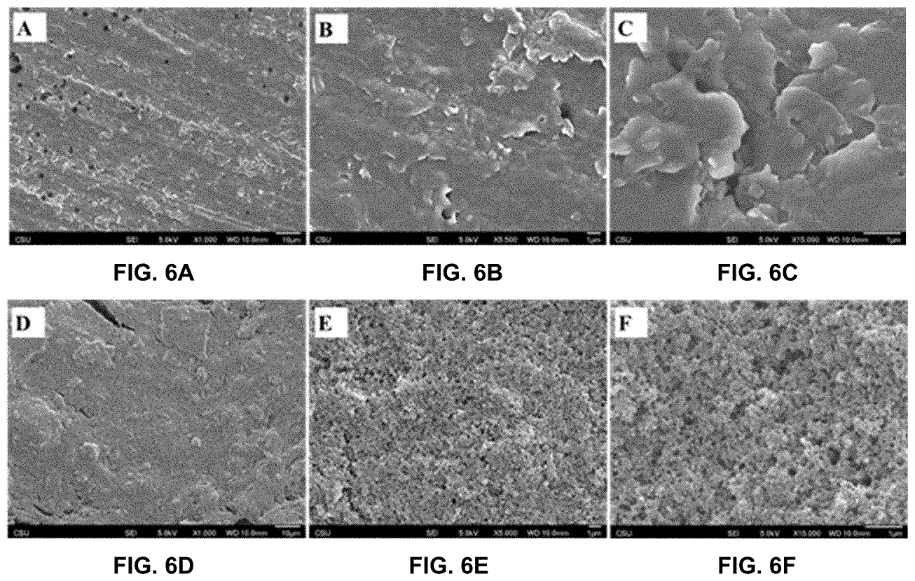

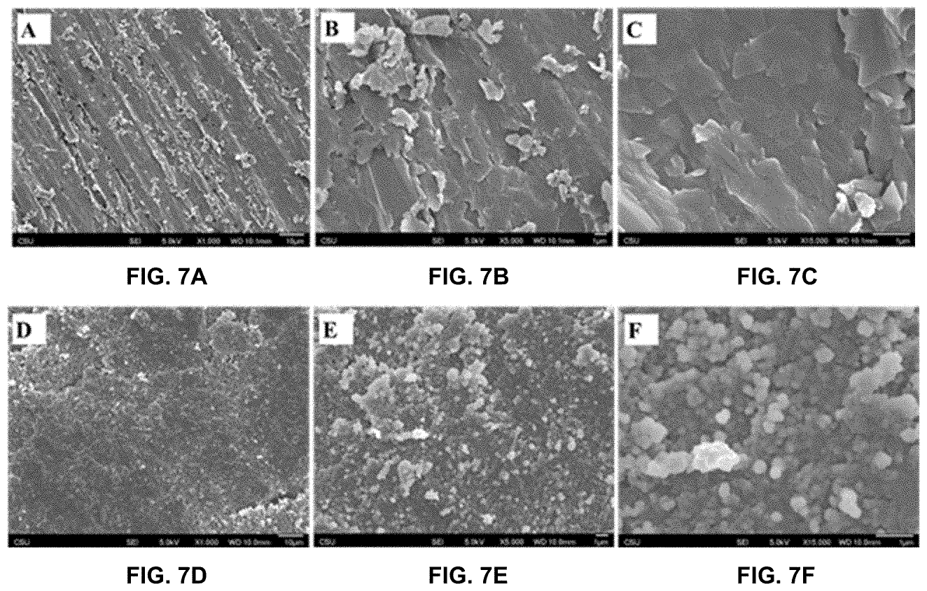

The morphologies of the bare MG199- and Nano19-based TPEs, CB-modified TPEs and CB-ISM modified TPEs were evaluated by SEM. As can be seen in FIG. 6 and FIG. 7, the CB layer was uniformly coated on TPE surface. In FIG. 6 (FIG. 6C and FIG. 6F) and FIG. 7 (FIG. 7C and FIG. 7F), it is clearly seen that CB filled the free space in the Nano19 and MG1599 network. These characterizations demonstrate that bare MG199- and Nano19-based TPEs have smoother surfaces than CB-modified TPEs. Therefore, increased surface area of the electrodes were obtained due the smaller size and increased amount of conductive material on the TPE surfaces, resulting in better electrochemical response and lack of noise [58].

### Example 7: Calibration Curves and Selectivity

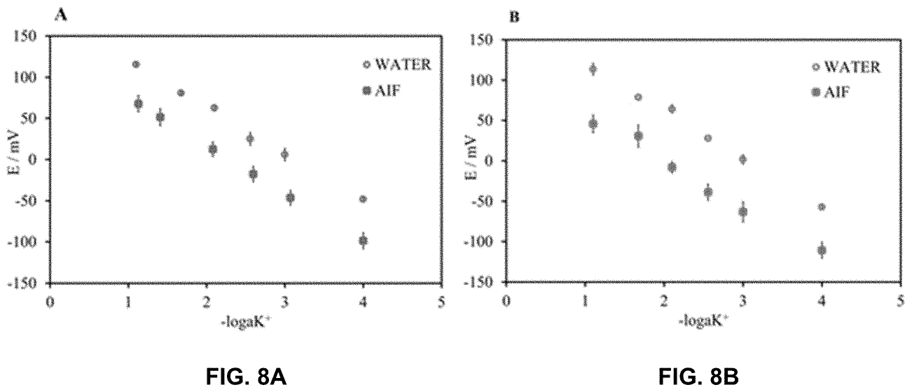

Calibration curves obtained for potassium in two different solutions including water and AIF are presented in FIG. 8A and FIG. 8B. The slopes were 56.8 mV decade-1 and 59.3 mV decade-1 in water while they were 58.1 mV decade-1 and 57 mV decade-1 in AIF for MG1599 and Nano19-based ISEs, respectively. The LODs (1.0×10-4 M) and the linear range of potentiometric responses (from 10-4 to 10-1.1 M), which is within the range of both healthy and harmful levels in human, were similar in water and AIF background.

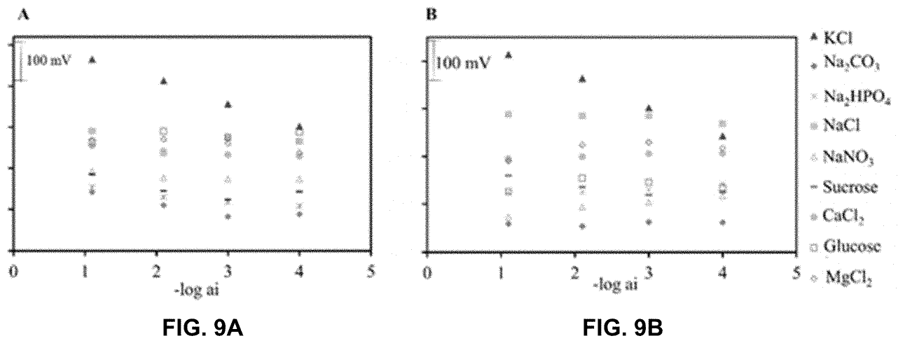

Another important parameter for potentiometric ISEs is selectivity since it is important to detect the target ion in the presence of other ions. Therefore, selectivity measurements of the TPEs were performed in the presence of 0.1 M to 10-4 M concentrations of common metabolites present in biofluids. As can be seen in FIG. 9A and FIG. 9B, the interfering species did not show noticeable potential drift, indicating that these species have no interference with the K⁺ detection. Thus, the developed electrodes can selectively measure potassium in complex matrixes.

### Example 8: Reproducibility, Repeatability and Stability of TPEs

The reproducibility of TPEs was tested using five separate electrodes, while the repeatability of the electrodes was evaluated using the same electrode run five times.

According to slopes in Table 7, the relative standard deviations (RSDs) of MG1599-based ISEs for repeatability and reproducibility were 1.2% and 2.3%, whereas they were 0.8% and 3.1% for Nano19-based TPEs, respectively. The lifetime of the ISEs were investigated weekly for 60 days by measuring the slope and LOD. The electrodes were kept under dry conditions in closed glass vials when not in use and were re-conditioned in 10-1 M K⁺ ion solution before use. The observed slopes changed from 56.8±1.7 mV decade-1 to 56.2±0.9 mV decade-1 and from 59.3±1.01 mV decade-1 to 58.7±0.52 mV decade-1 of activity for MG1599 and Nano19-based electrodes for K⁺ ions, respectively after one month, which were not significant, revealing high stability.

TABLE 7
Reproducibility and repeatability of MG1599 and Nano19-based K⁺-ISEs.

| | Slopes | Slopes | | Linear |
|---|---|---|---|---|
| | (mV/logₐK⁺) | (mV/ logₐK⁺) | LOD | (activity) |
| | MG 1599 | Nano19 | (activity) | Range |
| Reproducibility | 58.5, 57.0, | 60.6, 60.5, | 10⁻⁴ | 10⁻⁴-10^{-1.1} |
| | 56.7, | 58.7, | | |
| | 56.3, 54.9 | 59.8, 56.2 | | |
| Repeatability | 58.9, 58.5, | 59.8, 59.1, | 10⁻⁴ | 10⁻⁴-10^{-1.1} |
| | 57.8, | 59.7, | | |
| | 57.3, 57.3 | 59.4, 58.7 | | |

### Example 9: Response Time

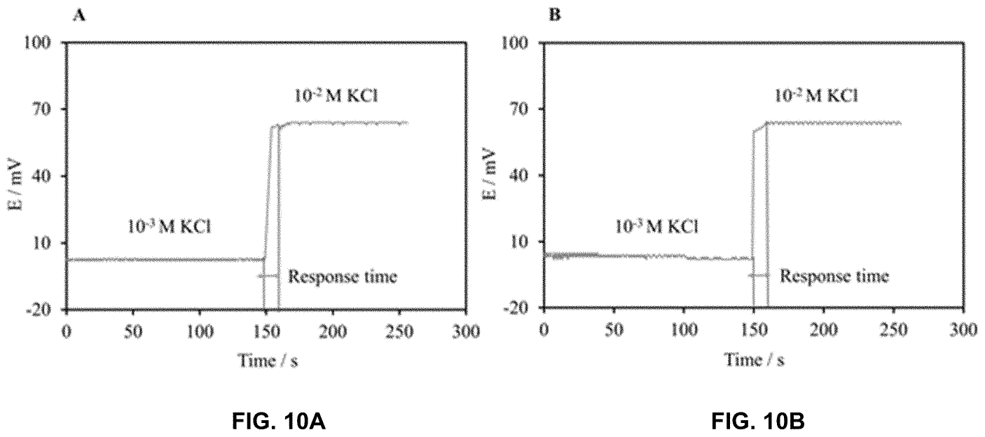

To evaluate the response time of the electrode, the average time required for the electrode to reach a potential response within ±1.0 mV of the final equilibrium value after increasing the primary ion solution by a factor of 10-fold was recorded (FIG. 10A and FIG. 10B). The potentiometric response time is found to be 4 s for both K⁺-ISE. The rapid response of the electrodes could be due to the lack of the internal reference solution.

### Example 10: pH Test

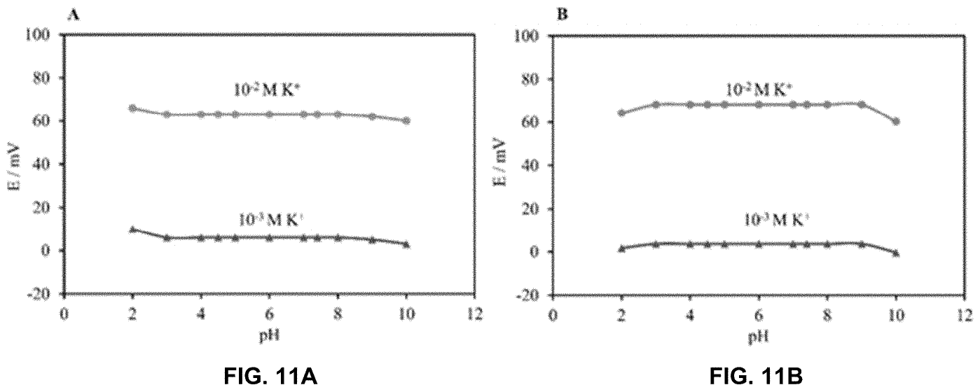

The effect of pH on the potentiometric response of the electrodes was investigated using 1.0×10-2 and 1.0×10-3 M K⁺ ion concentrations over a pH range of 2.0-10.0. The pH was adjusted by adding small drops of hydrochloric acid (1 M) or sodium hydroxide (1 M) to the solutions. The effect of pH on the potentiometric response of the electrodes is shown in (FIG. 11A and FIG. 11B). The potentiometric signal of K⁺-selective TPEs based on MG199 remained constant from pH 3.0 to 9.0, followed by a 2 mV change in the pH range of 9-10 for 10-2 M and 10-3 M KCl. Similarly, K⁺-selective TPEs based on Nano19 showed stable potentiometric response from pH 3.0 to 9.0, and 8 mV and 4 mV drift in the pH range of 9.0-10.0 for 10-2 M and 10-3 M KCl, respectively.

### Example 11: Water Layer Test

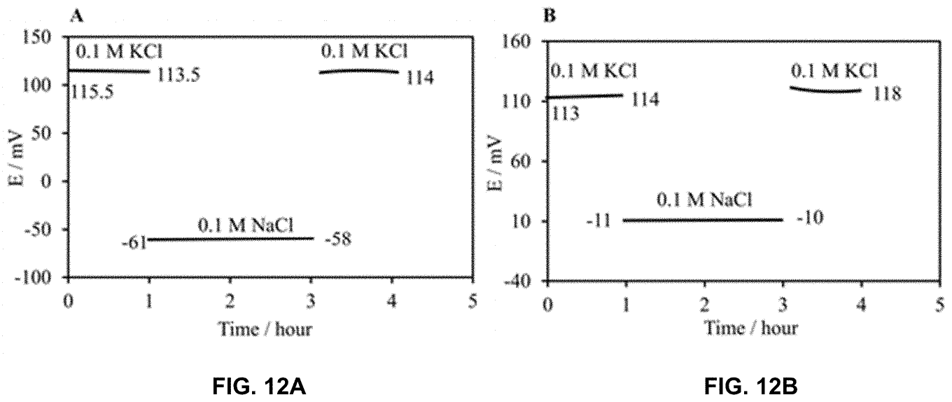

To investigate the potential instability due to the formation of an unwanted aqueous film between the polymeric membrane and the solid contact, a potentiometric water layer test was performed. At first, the electrode response was sequentially measured in 0.1 M KCl solution for 1 h, then solution was changed to an interfering ion for 2 h followed by 0.1 M of the primary ion again. As shown in FIG. 12A and FIG. 12B, K⁺-ISEs showed a potential drop with a drift when the K⁺ solution was replaced with Na⁺. A similar drift was obtained after the electrode was immersed in the K⁺ solution due to the diffusion of K⁺ to the layer. The potential returned to the initial value once the KCl solution was introduced to the electrodes again, suggesting the prevention of the formation of a water film at the ISM/CB-TPE solid contact interface owing to its highly hydrophobic surface. Carbon black has been shown as a solid contact ingredient to enhance the hydrophobicity of intermediate layer between polymeric membrane [59]. Consequently, the storage of potassium ions between membrane and substrate was not a problem due to the prevention of an unwanted water layer at the interface.

### Example 12: Real Sample Analysis

K⁺ ions spiked 5 mL of AIF (artificial interstitial fluid) samples and 100 times diluted human pooled urine samples (at pH 6) in 10 mM HEPES at pH 7.4 were used to perform the open circuit potential for sample analysis within the physiological ranges in both healthy and harmful conditions. The potassium activities in the urine and AIF sample were calibrated and, the activities of K⁺ ions were calculated based on the linear correlation between the logarithmic activities of primary ions and the calibrated potential value. The obtained data is presented in Table 8, which shows the potential application of CB-modified TPEs for detection of K⁺ ions in biofluids.

TABLE 8
Detection of K⁺ Ions in Human Pooled Urine and AIF Samples

| | | MG1599 | | Nano19 | |
|---|---|---|---|---|---|
| | Added | Found | Recovery | Found | Recovery |
| Sample | (mM) | (mM) | (%) | (mM) | (%) |
| AIF | 1.9 | 1.88 | 98.7 | 1.94 | 102.1 |
| AIF | 2.4 | 2.36 | 98.3 | 2.42 | 100.8 |
| Human urine | 3.0 | 2.75 | 91.7 | 3.08 | 102.7 |

### Example 13: Preparation of Reference Electrode

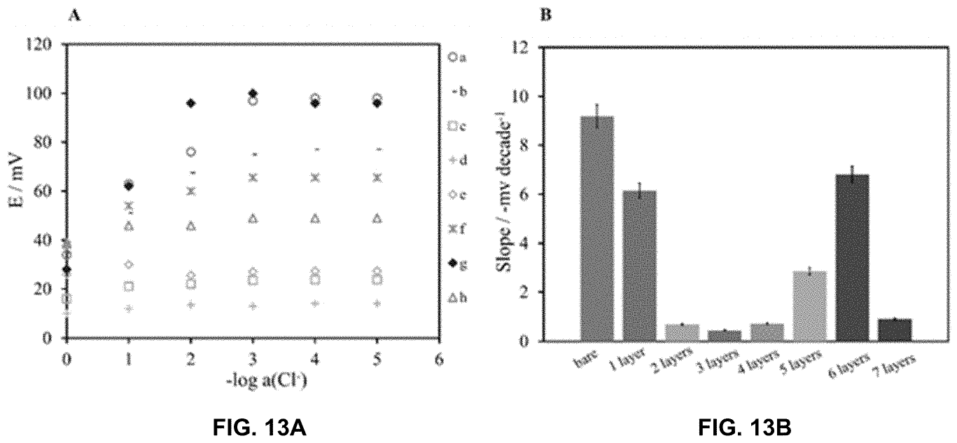

The TPE reference electrodes were fabricated using Ag/AgCl ink. In potentiometric measurements, however, Ag/AgCl ink can cause instabilities in the electrochemical response due to effect of chloride ions present in samples. [63] Bare Ag/AgCl electrodes respond strongly to Cl-ions (FIG. 13A), in agreement with previous reports,[64,65] making them unsuitable for most biological samples. Therefore, the reference electrode needs to be modified with a membrane. Here, a previously published procedure was modified and used for preparation of a reference membrane.[63] The volume of the reference membrane dropcast on TPE surfaces was optimized after conditioning in 3 M KCl for 16 h and sensitivities were compared with a commercial RE.[66] As seen in FIG. 13B, the slope of bare Ag/AgCl/TPE conditioned in 3 M KCl for 16 h was −9.2 mV decade-1, showing lower response to Cl⁻ ions compared to the unconditioned bare Ag/AgCl/TPEs (˜49.4 mV decade-1). Conditioning the reference TPE clearing impacts sensitivity to changes in salt concentration. In FIG. 13B, the slope of Ag/AgCl/TPE coated with three layers of reference membrane (6 μL) after conditioning in 3 M KCl for 16 h was the smallest (˜0.45 mV decade-1) among other reference TPEs, indicating a strong attachment to the TPE surface resulting in reduced porosity and salt leakage.[67] The slope of reference TPEs increased with increasing volume of reference membrane from three layers (6 μL) to seven layers (14 μL), which might be due to prevention of polymeric reference membrane equilibration at membrane-solution interface. During conditioning step, Cl⁻ mobility might have been decreased through the reference membrane because the membrane was too thick.[66] Thus, 6 μL (3 layers×2 μL) was used to modify TPE surface and the 16 h conditioning step was applied to RE prior to analysis for further experiments.

### Example 14: μPAD Fabrication

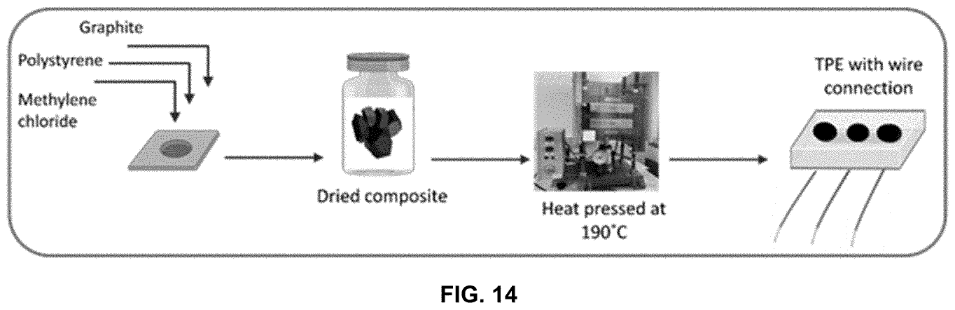

Microfluidic paper-based devices (μPADs) were fabricated according to previous reports.[68, 69] The μPAD was designed using CoreIDRAW. Whatman 4 filter paper with a pore diameter of 22 μm was used for fabrication of the device. After 4-pt line thick wax barriers on the paper was printed by a ColorQube 8870 wax printer (Xerox, Connecticut), a hot plate was used to melt the wax at 120° C. for 120 s. The outlet reservoir was created as a 270° wicking fan with a diameter of 40 mm. Packing tape was used to cover the μPAD to prevent evaporation. An image of the TPE array coupled to μPAD is shown in FIG. 14.

### Example 15: μPAD Application in Biological Fluids

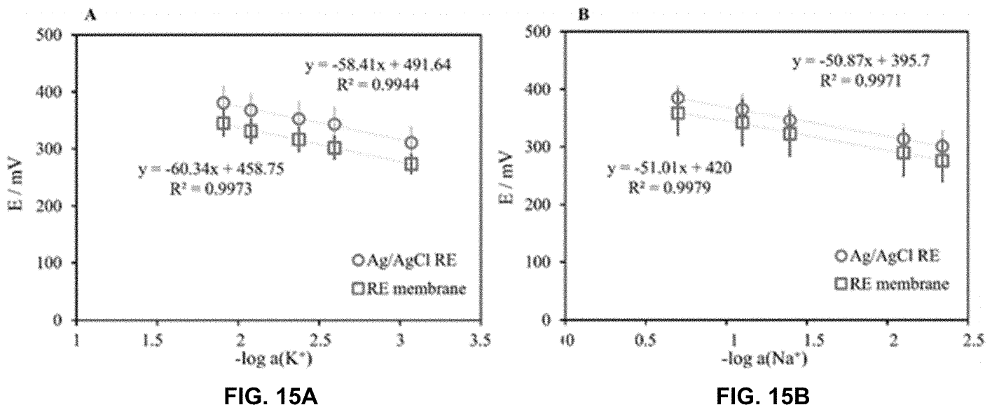

After the potassium-selective TPE was optimized, TPE array integrated with a paper-based device was tested to enable handling biological samples. The physiological ranges of Na⁺ and K⁺ in human serum are 130-260 mM and 2.5-12.5 mM, respectively. [70, 71]. Calibration curves for Na⁺ and K⁺ ions in artificial serum were obtained using the μPAD-TPE platform using both standard Ag/AgCl and polymeric membrane TPE reference electrodes. K⁺-selective TPEs demonstrated linear behavior in the range from 10-4 M and 10-1 M with a slope equal to 60.3 mV decade-1 and 58.4 mV decade-1, respectively for all-solid-state and external reference electrodes (FIG. 15A). The response of the TPEs in the solutions was linear in the range within 10-3 M and 1 M sodium ions with a slope equal to 51.0 mV decade-1 and 50.9 mV decade-1, respectively for all-solid-state and external reference electrodes (FIG. 15B). Next, a recovery study was performed by spiking artificial serum with 3 mM, 25 mM and 125 mM Na⁺ and 2.5 mM, 7.5 mM and 12.5 mM Na⁺ for simultaneous detection of Na⁺ and K⁺ ions. Accuracy of the μPAD-TPE array was investigated using recovery study and percentage average recoveries were calculated 101.3% and 99.8% for K⁺-TPE and Na⁺-TPE, respectively (Table 9). These results demonstrate that the integrated system is capable of making accurate measurements of complex biological samples.

TABLE 9
Detection of K⁺ and Na⁺ ions in human serum samples

| | K⁺ | | | Na⁺ | | |
|---|---|---|---|---|---|---|
| Sam- | Added | Found | Recovery | Added | Found | Recover |
| ple | (mM) | (mM) | (%) | (mM) | (mM) | (%) |
| AIS | 2.50 | 2.55 ± 0.35 | 102.0 | 3.0 | 2.94 ± 0.15 | 98.0 |
| AIS | 7.50 | 7.66 ± 0.13 | 102.1 | 25.0 | 25.3 ± 0.12 | 101.3 |
| AIS | 12.5 | 12.48 ± 0.07 | 99.8 | 125.0 | 124.7 ± 0.13 | 99.8 |

### REFERENCES

[1] P. Pirovano, M. Dorrian, A. Shinde, A. Donohoe, A. J. Brady, N. M. Moyna, G. Wallace, D. Diamond, M. McCaul, A wearable sensor for the detection of sodium and potassium in human sweat during exercise, Talanta, 219 (2020) 121145.
[2] S. Komaba, J. Arakawa, M. Seyama, T. Osaka, I. Satoh, S. Nakamura, Flow injection analysis of potassium using an all-solid-state potassium-selective electrode as a detector, Talanta, 46 (1998) 1293-1297.
[3] T. Zhang, X. Chang, W. Liu, X. Li, F. Wang, L. Huang, S. Liao, X. Liu, Y. Zhang, Y. Zhao, Comparison of sodium, potassium, calcium, magnesium, zinc, copper and iron concentrations of elements in 24-h urine and spot urine in hypertensive patients with healthy renal function, Journal of Trace Elements in Medicine and Biology, 44 (2017) 104-108.
[4] W. Gao, G. A. Brooks, D. C. Klonoff, Wearable physiological systems and technologies for metabolic monitoring, Journal of applied physiology, 124 (2018) 548-556.
[5] M. Odijk, E. Van Der Wouden, W. Olthuis, M. Ferrari, E. Tolner, A. Van Den Maagdenberg, A. van den Berg, Microfabricated solid-state ion-selective electrode probe for measuring potassium in the living rodent brain: Compatibility with D C-EEG recordings to study spreading depression, Sensors and Actuators B: Chemical, 207 (2015) 945-953.
[6] E. Scurati-Manzoni, E. F. Fossali, C. Agostoni, E. Riva, G. D. Simonetti, M. Zanolari-Calderari, M. G. Bianchetti, S. A. Lava, Electrolyte abnormalities in cystic fibrosis: systematic review of the literature, Pediatric Nephrology, 29 (2014) 1015-1023.
[7] S. N. Cheuvront, R. CARTER 3rd, M. N. Sawka, Fluid balance and endurance exercise performance, Current sports medicine reports, 2 (2003) 202-208.
[8] A. S. Lima, N. Bocchi, H. M. Gomes, M. F. Teixeira, An electrochemical sensor based on nanostructured hollandite-type manganese oxide for detection of potassium ions, Sensors, 9 (2009) 6613-6625.
[9] I. S. El Otmani, A. Jarmoumi, M. Bouatia, B. Mojemmi, M. O. Idrissi, M. Draoui, N. Kamal, Correlation study between two analytical techniques used to measure serum potassium: An automated potentiometric method and flame photometry reference method, J. Chem. Pharmaceutical Res., 7 (2015) 862-867.
[10] B.-S. Yu, L.-H. Nie, S.-Z. Yao, Ion chromatographic study of sodium, potassium and ammonium in human body fluids with bulk acoustic wave detection, Journal of Chromatography B: Biomedical Sciences and Applications, 693 (1997) 43-49.
[11] H. Chen, Y.-S. Gal, S.-H. Kim, H.-J. Choi, M.-C. Oh, J. Lee, K. Koh, Potassium ion sensing using a self-assembled calix [4] crown monolayer by surface plasmon resonance, Sensors and Actuators B: Chemical, 133 (2008) 577-581.
[12] H. Dai, Y. Wang, C. Ren, X. Ji, Y. Zhou, X. Zhang, F. Yin, W. Yin, Z. Tao, A new method for detecting Na⁺, K⁺-ATPase activity by ICP-MS: Quantitative analysis on the inhibitory effect of rhein on Na⁺, K⁺-ATPase activity by ICP-MS in HCT116 cells, Biomedical Chromatography, (2021) e5199.
[13] A. Ruiz-Gonzalez, K. L. Choy, Highly selective and robust nanocomposite-based sensors for potassium ions detection, Applied Materials Today, 23 (2021) 101008.
[14] J. Bobacka, A. Ivaska, A. Lewenstam, Potentiometric ion sensors, Chemical reviews, 108 (2008) 329-351.
[15] E. Lindner, R. E. Gyurcsenyi, Quality control criteria for solid-contact, solvent polymeric membrane ion-selective electrodes, Journal of Solid State Electrochemistry, 13 (2009) 51-68.
[16] H. Karimi-Maleh, Y. Orooji, F. Karimi, M. Alizadeh, M. Baghayeri, J. Rouhi, S. Tajik, H. Beitollahi, S. Agarwal, V. K. Gupta, A critical review on the use of potentiometric based biosensors for biomarkers detection, Biosensors and Bioelectronics, (2021) 113252.
[17] C. R. Rousseau, P. Buhlmann, Calibration-free potentiometric sensing with solid-contact ion-selective electrodes, TrAC Trends in Analytical Chemistry, (2021) 116277.
[18] E. Bakker, E. Pretsch, Modern potentiometry, Angewandte Chemie International Edition, 46 (2007) 5660-5668.
[19] R. W. Cattrall, H. Freiser, Coated wire ion-selective electrodes, Analytical chemistry, 43 (1971) 1905-1906.
[20] S. Papp, J. Kozma, T. Lindfors, R. E. Gyurcsenyi, Lipophilic Multi-walled Carbon Nanotube-based Solid Contact Potassium Ion-selective Electrodes with Reproducible Standard Potentials. A Comparative Study, Electroanalysis, 32 (2020) 867-873.
[21] T. Yin, D. Pan, W. Qin, All-solid-state polymeric membrane ion-selective miniaturized electrodes based on a nanoporous gold film as solid contact, Analytical chemistry, 86 (2014) 11038-11044.
[22] K. Yu, N. He, N. Kumar, N. Wang, J. Bobacka, A. Ivaska, Electrosynthesized polypyrrole/zeolite composites as solid contact in potassium ion-selective electrode, Electrochimica Acta, 228 (2017) 66-75.
[23] J.-P. Veder, R. De Marco, K. Patel, P. Si, E. Grygolowicz-Pawlak, M. James, M. T. Alam, M. Sohail, J. Lee, E. Pretsch, Evidence for a surface confined ion-to-electron transduction reaction in solid-contact ion-selective electrodes based on poly (3-octylthiophene), Analytical chemistry, 85 (2013) 10495-10502.
[24] Z. A. Boeva, T. Lindfors, Few-layer graphene and polyaniline composite as ion-to-electron transducer in silicone rubber solid-contact ion-selective electrodes, Sensors and Actuators B: Chemical, 224 (2016) 624-631.
[25] W. Gao, S. Emaminejad, H. Y. Y. Nyein, S. Challa, K. Chen, A. Peck, H. M. Fahad, H. Ota, H. Shiraki, D. Kiriya, Fully integrated wearable sensor arrays for multiplexed in situ perspiration analysis, Nature, 529 (2016) 509-514.
[26] L. van de Velde, E. d'Angremont, W. Olthuis, Solid contact potassium selective electrodes for biomedical applications—a review, Talanta, 160 (2016) 56-65.
[27] S. Wang, Y. Wu, Y. Gu, T. Li, H. Luo, L.-H. Li, Y. Bai, L. Li, L. Liu, Y. Cao, Wearable sweatband sensor platform based on gold nanodendrite array as efficient solid contact of ion-selective electrode, Analytical chemistry, 89 (2017) 10224-10231.
[28] K. Tsuchiya, T. Akatsuka, Y. Abe, S. Komaba, Design of all-solid-state chloride and nitrate ion-selective electrodes using anion insertion materials of electrodeposited poly (allylamine)-MnO₂ composite, Electrochimica Acta, (2021) 138749.
[29] F. Wang, Y. Liu, M. Zhang, F. Zhang, P. He, Home Detection Technique for Na⁺ and K⁺ in Urine Using a Self-Calibrated all-Solid-State Ion-Selective Electrode Array Based on Polystyrene-Au Ion-Sensing Nanocomposites, Analytical Chemistry, (2021).
[30] C. Dorrer, J. Rahe, Some thoughts on superhydrophobic wetting, Soft Matter, 5 (2009) 51-61.
[31] F. Arduini, S. Cinti, V. Mazzaracchio, V. Scognamiglio, A. Amine, D. Moscone, Carbon black as an outstanding and affordable nanomaterial for electrochemical (bio) sensor design, Biosensors and Bioelectronics, 156 (2020) 112033.
[32] S. Cinti, F. Arduini, M. Carbone, L. Sansone, I. Cacciotti, D. Moscone, G. Palleschi, Screen-printed electrodes modified with carbon nanomaterials: a comparison among carbon black, carbon nanotubes and graphene, Electroanalysis, 27 (2015) 2230-2238.
[33] C. H. A. Wong, A. Ambrosi, M. Pumera, Thermally reduced graphenes exhibiting a close relationship to amorphous carbon, Nanoscale, 4 (2012) 4972-4977.
[34] K. J. Klunder, Z. Nilsson, J. B. Sambur, C. S. Henry, Patternable Solvent-Processed Thermoplastic Graphite Electrodes, J. Am. Chem. Soc., 139 (2017) 12623-12631.
[35] K. J. Klunder, K. M. Clark, C. McCord, K. E. Berg, S. D. Minteer, C. S. Henry, Polycaprolactone-enabled sealing and carbon composite electrode integration into electrochemical microfluidics, Lab Chip, 19 (2019) 2589-2597.
[36] E. Noviana, K. J. Klunder, R. B. Channon, C. S. Henry, Thermoplastic Electrode Arrays in Electrochemical Paper-Based Analytical Devices, Analytical Chemistry, 91 (2019) 2431-2438.
[37] K. E. Berg, Y. R. Leroux, P. Hapiot, C. S. Henry, Increasing Applications of Graphite Thermoplastic Electrodes with Aryl Diazonium Grafting, ChemElectroChem, 6 (2019) 4811-4816.
[38] L. A. Pradela-Filho, E. Noviana, D. Araujo, R. Takeuchi, A. Santos, C. S. Henry, Rapid Analysis in Continuous Flow Electrochemical Paper-Based Analytical Devices, ACS Sens., (2020).
[39] T. Ozer, C. McCord, B. J. Geiss, D. Dandy, C. S. Henry, Thermoplastic Electrodes for Detection of Escherichia coli, Journal of The Electrochemical Society, 168 (2021) 047509.
[40] K. E. Berg, K. M. Clark, X. Li, E. M. Carter, J. Volckens, C. S. Henry, High-throughput, semi-automated dithiothreitol (DTT) assays for oxidative potential of fine particulate matter, Atmospheric Environment, 222 (2020) 117132.
[41] C. P. McCord, B. Summers, C. S. Henry, Redox Behavior and Surface Morphology of Polystyrene Thermoplastic Electrodes, Electrochimica Acta, (2021) 139069.
[42] K. Salminen, P. Grönroos, J. Eskola, E. Nieminen, H. Harms, S. Kulmala, Immunoassay of C-reactive protein by hot electron-induced electrochemiluminescence at polystyrene-carbon black composite electrodes, Electrochimica Acta, 282 (2018) 147-154.
[43] L. Saghatforoush, M. Hasanzadeh, N. Shadjou, Polystyrene-graphene oxide modified glassy carbon electrode as a new class of polymeric nanosensors for electrochemical determination of histamine, Chinese Chemical Letters, 25 (2014) 655-658.
[44] W. Liu, J. Xiao, C. Wang, H. Yin, H. Xie, R. Cheng, Synthesis of polystyrene-grafted-graphene hybrid and its application in electrochemical sensor of dopamine, Materials Letters, 100 (2013) 70-73.
[45] A. R. Khaskheli, J. Fischer, J. Barek, V. Vyskocil, Sirajuddin, M. I. Bhanger, Differential pulse voltammetric determination of paracetamol in tablet and urine samples at a micro-crystalline natural graphite-polystyrene composite film modified electrode, Electrochimica Acta, 101 (2013) 238-242.
[46] Y. Lu, X. Wang, D. F. Chen, G. Chen, Polystyrene/graphene composite electrode fabricated by in situ polymerization for capillary electrophoretic determination of bioactive constituents in Herba Houttuyniae, Electrophoresis, 32 (2011) 1906-1912.
[47] M. Parrilla, M. Cuartero, S. Padrell Senchez, M. Rajabi, N. Roxhed, F. Niklaus, G.n.A. Crespo, Wearable all-solid-state potentiometric microneedle patch for intradermal potassium detection, Analytical chemistry, 91 (2018) 1578-1586.
[48] A. Bretag, Synthetic interstial fluid for isolated mammalian tissue, Life sciences, 8 (1969) 319-329.
[49] W. Gao, E. Zdrachek, X. Xie, E. Bakker, A Solid-State Reference Electrode Based on a Self-Referencing Pulstrode, Angewandte Chemie International Edition, 59 (2020) 2294-2298.
[50] E. Bakker, E. Pretsch, P. Buhlmann, Selectivity of potentiometric ion sensors, Analytical chemistry, 72 (2000) 1127-1133.
[51] T. A. Ali, A. A. Abd-Elaal, G. G. Mohamed, Screen printed ion selective electrodes based on self-assembled thiol surfactant-gold-nanoparticles for determination of Cu (I I) in different water samples, Microchemical Journal, 160 (2021) 105693.
[52] K. N. Mikhelson, Ion-selective electrodes, Springer2013.
[53] E. Bakker, P. Buhlmann, E. Pretsch, Carrier-based ion-selective electrodes and bulk optodes. 1. General characteristics, Chemical Reviews, 97 (1997) 3083-3132.
[54] A. D. McNaught, A. Wilkinson, Compendium of chemical terminology, Blackwell Science Oxford 1997.
[55] J. Bobacka, Potential stability of all-solid-state ion-selective electrodes using conducting polymers as ion-to-electron transducers, Analytical chemistry, 71 (1999) 4932-4937.
[56] V. Mazzaracchio, A. Serani, L. Fiore, D. Moscone, F. Arduini, All-solid state ion-selective carbon black-modified printed electrode for sodium detection in sweat, Electrochimica Acta, (2021) 139050.
[57] J. Ping, Y. Wang, K. Fan, W. Tang, J. Wu, Y. Ying, High-performance flexible potentiometric sensing devices using free-standing graphene paper, Journal of Materials Chemistry B, 1 (2013) 4781-4791.
[58] M. Pacios, M. Del Valle, J. Bartroli, M. Esplandiu, Electrochemical behavior of rigid carbon nanotube composite electrodes, Journal of Electroanalytical Chemistry, 619 (2008) 117-124.
[59] M. Piek, B. Paczosa-Bator, J. Smajdor, R. Piech, Molecular organic materials intermediate layers modified with carbon black in potentiometric sensors for chloride determination, Electrochimica Acta, 283 (2018) 1753-1762.
[60] Guinovart, T.; Crespo, G. A.; Rius, F. X.; Andrade, F. J., A reference electrode based on polyvinyl butyral (PVB) polymer for decentralized chemical measurements. Analytica chimica acta 2014, 821, 72-80.
[61] N. Lenar, B. Paczosa-Bator, R. Piech, Ruthenium dioxide as high-capacitance solid-contact layer in K⁺-selective electrodes based on polymer membrane, Journal of The Electrochemical Society, 166 (2019) B1470.
[62] N. Lenar, B. Paczosa-Bator, R. Piech, Ruthenium dioxide nanoparticles as a high-capacity transducer in solid-contact polymer membrane-based pH-selective electrodes, Microchimica Acta, 186 (2019) 1-11.
[63] Ding, J.; Li, B.; Chen, L.; Qin, W., A Three-Dimensional Origami Paper-Based Device for Potentiometric Biosensing. Angewandte Chemie International Edition 2016, 55 (42), 13033-13037.
[64] Rose, D. P.; Ratterman, M. E.; Griffin, D. K.; Hou, L.; Kelley-Loughnane, N.; Naik, R. R.; Hagen, J. A.; Papautsky, I.; Heikenfeld, J. C., Adhesive RFID sensor patch for monitoring of sweat electrolytes. IEEE Transactions on Biomedical Engineering 2014, 62 (6), 1457-1465.
[65] da Silva, E. T. S. G. n.; Miserere, S.; Kubota, L. T.; Merkoçi, A., Simple on-plastic/paper inkjet-printed solid-state Ag/AgCl pseudoreference electrode. Analytical chemistry 2014, 86 (21), 10531-10534.
[66] Guinovart, T.; Crespo, G. A.; Rius, F. X.; Andrade, F. J., A reference electrode based on polyvinyl butyral (PVB) polymer for decentralized chemical measurements. Analytica chimica acta 2014, 821, 72-80.
[67] Mousavi, Z.; Granholm, K.; Sokalski, T.; Lewenstam, A., An analytical quality solid-state composite reference electrode. Analyst 2013, 138 (18), 5216-5220.
[68] Pradela-Filho, L. A.; Noviana, E.; Araujo, D. A.; Takeuchi, R. M.; Santos, A. L.; Henry, C. S., Rapid analysis in continuous-flow electrochemical paper-based analytical devices. ACS sensors 2020, 5 (1), 274-281.
[69] Pradela-Filho, L. A.; Noviana, E.; Araujo, D. A.; Takeuchi, R. M.; Santos, A. L.; Henry, C. S., Rapid analysis in continuous-flow electrochemical paper-based analytical devices. ACS sensors 2020, 5 (1), 274-281.
[70] Howard, G., Measurement of sodium and potassium in clinical chemistry. A review. Analyst 1988, 113 (3), 373-384.
[71] Byrne, C.; Pareek, M.; Vaduganathan, M.; Biering-Sorensen, T.; Krogager, M. L.; Kragholm, K. H.; Steensig, K.; Mortensen, M. B.; Mishra, S. R.; McCullough, M. J., Serum Potassium and Mortality in High-Risk Patients: SPRINT. Hypertension 2021, HYPERTENSIONAHA. 121.17736.

What is claimed is:

1. A potentiometric ion selective electrode, the potentiometric ion selective electrode comprising:
(a) a thermoplastic composite electrode;
(b) a water impermeable layer; and
(c) an ion selective membrane;
wherein the water impermeable layer is layered on the surface of the thermoplastic composite electrode and wherein the ion selective membrane is layered on the surface of the water impermeable layer.

2. The potentiometric ion selective electrode of claim 1, further comprising an electrical conductor that is in contact with the thermoplastic composite electrode.

3. The potentiometric ion selective electrode of claim 1, wherein the thermoplastic electrode comprises a uniform dispersion of one or more plastic binder(s) and a carbon allotrope.

4. The potentiometric ion selective electrode of claim 3, wherein the one or more plastic binder(s) comprises polystyrene, polycaprolactone, polypropylene, polyethylene, polyaniline, polyurethane, polyacrylate, or combinations thereof.

5. The potentiometric ion selective electrode of claim 3, wherein the carbon allotrope comprises graphite, expanded graphite, graphite oxide, graphene, boron doped diamond, graphene oxide, graphene, glassy carbon, vitreous carbon, carbon nanotubes, carbon nanoplatelets, carbon black, fullerenes, or a combination thereof.

6. The potentiometric ion selective electrode of claim 1, wherein the ion selective membrane comprises an ionic liquid, an ionophore, a polymer, a plasticizer, or a combination thereof.

7. The potentiometric ion selective electrode of claim 1, wherein the potentiometric electrode ion selective electrode measures activity of aqueous inorganic anions or aqueous inorganic cations in a solution.

8. The potentiometric ion selective electrode of claim 1, wherein the concentration of the inorganic anions or inorganic cations from about 1.0×10-5 M to about 1.0 M and the potentiometric ion selective has a size ranging from about 10 μm to about 10 mm.

9. A method for preparing potentiometric ion selective electrodes, the methods comprising:
(a) providing a thermoplastic composite electrode;
(b) preparing a dispersion comprising of a water impermeable precursor;
(c) applying the water impermeable layer precursor to the thermoplastic carbon composite electrode;
(d) drying the water impermeable layer precursor on the thermoplastic carbon composite electrode forming the water impermeable layer;
(e) preparing a dispersion of an ion selective membrane precursor;
(f) applying the ion selective membrane precursor on the water impermeable layer;
(g) drying the ion selective membrane precursor forming the ion selective membrane electrode; and
(h) conditioning the ion selective membrane electrode;
wherein the thermoplastic carbon composite is in contact with an electrical conductor.

10. The method of claim 9, wherein the thermoplastic electrode comprises a uniform dispersion of a one or more plastic binder(s) and a carbon allotrope.

11. The method of claim 10, wherein the one or more plastic binder(s) comprises polystyrene, polycaprolactone, polypropylene, polyethylene, polyaniline, polyurethane, polyacrylate, or combinations thereof.

12. The method of claim 10, wherein the carbon allotrope comprises graphite, expanded graphite, graphite oxide, graphene, boron doped diamond, graphene oxide, graphene, glassy carbon, vitreous carbon, carbon nanotubes, carbon nanoplatelets, carbon black, fullerenes, or a combination thereof.

13. The method of claim 9, wherein the ion selective membrane precursor comprises an ionic liquid, a lipophilic additive, an ionophore, a polymer, a plasticizer, or a combination thereof.

14. The potentiometric ion selective electrode precursor of claim 13, wherein the ionophore is a neutral ionophore or a charged ionophore.

15. The potentiometric ion selective electrode precursor of claim 13, wherein the ionic liquid comprises an ammonium salt, an imidazolium salt, a morpholinium salt, a phosphonium salt, a piperidinium salt, a pyridinium salt, a pyrrolidinium salt, or a sulfonium salt.

16. The potentiometric ion selective electrode precursor of claim 13, wherein the lipophilic additive comprises a neutral molecule which binds an inorganic cation or an inorganic anion, a metal-ion complex, isoalloxazine derivatives, a crown ether, a phthalocyanine, porphyrins, or metalloporphyrins.

17. A microfluidic electrode array, the microfluidic electrode array comprising one or more potentiometric ion selective electrodes of claim 1 and a reference electrode, wherein the microfluidic electrode array is affixed to a hydrophilic base substrate.

18. The microfluidic electrode array of claim 17 wherein the microfluidic electrode array is connected to a microprocessor through a connection.

19. The microfluidic electrode array of claim 17, wherein the microfluidic electrode array is part of an electrode cartridge.

20. The microfluidic electrode array of claim 19, wherein the electrode cartridge is part of a hand-held mobile electrode device, a remote electrode cartridge device, or a fixed electrode cartridge device.

21. The microfluidic electrode array of claim 17, wherein the microfluidic electrode array is a fast-flow microfluidic analytical device.
